(19) United States
(12) Patent Application Publication
(10) Pub. No.: US 2015/0024277 A1
(43) Pub. Date: Jan. 22, 2015

(54) CARBONACEOUS MATERIAL FOR NON-AQUEOUS ELECTROLYTE SECONDARY BATTERY

(71) Applicant: Kureha Corporation, Tokyo (JP)

(72) Inventors: Mayu Komatsu, Tokyo (JP); Yasuhiro Tada, Tokyo (JP); Naohiro Sonobe, Tokyo (JP)

(21) Appl. No.: 14/375,899

(22) PCT Filed: Feb. 6, 2013
(86) PCT No.: PCT/JP2013/052697

§ 371 Date: Jul. 31, 2014

(30) Foreign Application Priority Data
Feb. 6, 2012 (JP) 2012-023428
Feb. 6, 2012 (JP) 2012-023429

(51) Int. Cl. H01M 4/583; H01M 10/0525

(52) U.S. Cl. CPC H01M 4/583; H01M 10/0525; H01M 2220/20
USPC 429/231.8; 585/16; 585/241; 585/240; 208/39; 208/14

(57) ABSTRACT

An object of the present invention is to provide a carbonaceous material for a non-aqueous electrolyte secondary battery having excellent output characteristics and exhibiting excellent cycle characteristics, and a negative electrode using the same.

The problem described above is solved by a carbonaceous material for a non-aqueous electrolyte battery having a true density of 1.4 to 1.7 g/cm³, an atom ratio (H/C) of hydrogen atoms to carbon atoms of at most 0.1, as determined by elemental analysis, an average particle size Dv₅₀ of 3 to 35 μm, a ratio Dv₉₀/Dv₁₀ of 1.05 to 3.00, and a degree of circularity of 0.50 to 0.95.

### TECHNICAL FIELD

The present invention relates to a carbonaceous material for a non-aqueous electrolyte secondary battery, a production method thereof, a negative electrode for a non-aqueous electrolyte secondary battery using the same, and a secondary battery. With the carbonaceous material for a non-aqueous electrolyte secondary battery according to the present invention, it is possible to produce a non-aqueous electrolyte secondary battery having excellent output characteristics and excellent cycle characteristics. With the negative electrode for a non-aqueous electrolyte secondary battery of the present invention exhibiting a specific active material density or electrode density, it is possible to produce a non-aqueous electrolyte secondary battery which maintains charge/discharge efficiency and exhibits excellent output characteristics.

### BACKGROUND OF THE INVENTION

In recent years, the notion of mounting large lithium ion secondary batteries, having high energy density and excellent output characteristics, in electric automobiles has been investigated in response to increasing concern over environmental issues. In small mobile device applications such as mobile telephones or notebook personal computers, the capacity per unit volume is important, so graphitic materials with a large density have primarily been used as negative electrode active materials. However, lithium-ion secondary batteries for automobiles are difficult to replace at an intermediate stage due to their large size and high cost. Therefore, durability is required to be the same as that of an automobile, so there is a demand for the realization of a life span of at least 10 years (high durability). When graphitic materials or carbonaceous materials with a developed graphite structure are used, there is a tendency for damage to occur due to crystal expansion and contraction caused by repeated lithium doping and de-doping, which diminishes the charging and discharging repetition performance. Therefore, such materials are not suitable as negative electrode materials for lithium-ion secondary batteries for automobiles which require high cycle durability. In contrast, non-graphitizable carbon is suitable for use in automobile applications from the perspective of involving little particle expansion and contraction due to lithium doping and de-doping and having high cycle durability (Patent Document 1). In addition, non-graphitizable carbon has a gentle charging and discharging curve in comparison to graphitic materials, and the potential difference with charge restriction is larger, even when rapid charging that is more rapid than the case where graphitic materials are used as negative electrode active materials is performed, so non-graphitizable carbon has the feature that rapid charging is possible. Furthermore, since non-graphitizable carbon has lower crystallinity and more sites capable of contributing to charging and discharging than graphitic materials, non-graphitizable carbon is also characterized by having excellent rapid charging and discharging (input/output) characteristics. However, there is a demand for rapid charging and discharging (input/output) characteristics that are outstanding in comparison to those of a lithium-ion secondary battery for small mobile devices, wherein the charging time, which is 1 to 2 hours for small mobile devices, is a few tens of seconds for a power supply for a hybrid automobile when taking into consideration the fact that energy is regenerated when braking, and discharging is also a few tens of seconds when taking into consideration the time of stepping on the acceleration pedal. The negative electrode material described in Patent Document 1 has high durability but is inadequate as a negative electrode material for a lithium-ion secondary battery for an automobile requiring outstanding charging and discharging characteristics, and further improvements in performance are anticipated.

The idea of securing a gap between negative electrode active materials of a negative electrode of a non-aqueous electrolyte secondary battery has been investigated previously in order to improve input/output characteristics. For example, a method of spheroidizing a negative electrode active substance (non-graphitizable carbonaceous material) has been disclosed as a method of securing a gap between negative electrode active materials (Patent Document 2). It has also been disclosed that high output characteristics and high charging and discharging capacity can be achieved by using a spherical non-graphitizable carbonaceous material for a negative electrode. However, the active material described in Patent Document 2 has insufficient durability, and further improvements in durability are necessary.

In addition, a method of setting the electrode density to an appropriate value in order to improve the input/output characteristics has been disclosed (Patent Document 3). It has also been disclosed that a secondary battery having a high capacity and high rapid charge-discharge cycle reliability can be obtained by setting the electrode density to 0.6 to 1.2 g/cm³. However, the input/output characteristics of the secondary battery described in Patent Document 2 are inadequate, and further improvements in input/output characteristics are necessary.

### CITATION LIST

### Patent Literature

Patent Document 1: Japanese Unexamined Patent Application Publication No. H08-064207A
Patent Document 2: Publication of the International Application in Pamphlet No. 2005/098998
Patent Document 3: Japanese Unexamined Patent Application Publication No. 2002-334693A

### SUMMARY OF INVENTION

### Technical Problem

A first object of the present invention is to provide a carbonaceous material for a non-aqueous electrolyte secondary battery having excellent output characteristics and exhibiting excellent cycle characteristics, a negative electrode using the same, and a secondary battery. A second object of the present invention is to provide a negative electrode for a non-aqueous electrolyte secondary battery which exhibits excellent output characteristics without reducing the charge/discharge efficiency, and a secondary battery using the same.

### Solution to Problem

As a result of conducting dedicated research on a carbonaceous material for a non-aqueous electrolyte secondary battery capable of exhibiting excellent cycle characteristics while maintaining sufficient output characteristics when used in a non-aqueous electrolyte secondary battery, which is the first object described above, the present inventors discovered that a carbonaceous material for a non-aqueous electrolyte secondary battery exhibiting excellent cycle characteristics can be obtained by altering the surface structure of the material by means of the pulverization of a heat-infusible carbon precursor before or after final heat treatment and by controlling the gaps between particles when used as a negative electrode by adjusting the particle size distribution.

Specifically, the present inventors discovered that a non-aqueous electrolyte secondary battery having excellent output characteristics and cycle characteristics can be obtained when a non-graphitizable carbonaceous material having an atom ratio (H/C) of hydrogen atoms to carbon atoms of at most 0.1, as determined by elemental analysis, and a degree of circularity of 0.50 to 0.95 is used as a negative electrode material of the non-aqueous electrolyte secondary battery. In particular, the present inventors discovered that a non-aqueous electrolyte secondary battery having excellent output characteristics and cycle characteristics can be obtained when a non-graphitizable carbonaceous material having an average particle size Dv₅₀ (μm) of 3 to 35 μm, a ratio Dv₉₀/Dv₁₀ of 1.05 to 3.00, and a degree of circularity of 0.50 to 0.95 is used as a negative electrode material for the non-aqueous electrolyte secondary battery.

In addition, the present inventors discovered that the carbonaceous material for a non-aqueous electrolyte secondary battery of the present invention can be easily produced by adjusting the Dv₉₀/Dv₁₀ of the resulting carbonaceous material for a negative electrode for a non-aqueous electrolyte secondary battery to the range of 1.05 to 3.00 by pulverizing or pulverizing and classifying a carbon precursor. That is, the present inventors discovered that a non-graphitizable carbonaceous material having the physical properties described above can be obtained by pulverizing and, if necessary, classifying a carbon precursor that does not melt when heated and then subjecting the carbon precursor to final heat treatment at a temperature of 900 to 1600° C.

Furthermore, as a result of conducting dedicated research on a negative electrode for non-aqueous electrolyte secondary battery exhibiting excellent output characteristics without reducing the charge/discharge efficiency, which is the second object described above, the present inventors discovered that a non-aqueous electrolyte secondary battery exhibiting excellent output characteristics can be obtained by using at least a non-graphitizable carbonaceous material having an atom ratio (H/C) of hydrogen atoms to carbon atoms of at most 0.1, as determined by elemental analysis, and a degree of circularity of 0.50 to 0.95 as a negative electrode active material and using a negative electrode for a non-aqueous electrolyte secondary battery having an active material density of 0.85 to 1.00 g/cc when a pressing pressure of 588 MPa (6.0 t/cm²) is applied. In addition, the present inventors discovered that a non-aqueous electrolyte secondary battery exhibiting excellent output characteristics can be obtained by using the non-graphitizable carbonaceous material described above as a negative electrode active material and using a negative electrode for a non-aqueous electrolyte secondary battery having an active material density of 0.87 to 1.12 g/cc when a pressing pressure of 588 MPa (6.0 t/cm²) is applied.

The present invention is based on such knowledge.

Consequently, the present invention provides:

[1] a carbonaceous material for a non-aqueous electrolyte battery having an atom ratio (H/C) of hydrogen atoms to carbon atoms of at most 0.1, as determined by elemental analysis, and a degree of circularity of 0.50 to 0.95;
[2] the carbonaceous material for a non-aqueous electrolyte battery according to [1], a true density being from 1.4 to 1.7 g/cm³;
[3] the carbonaceous material for a non-aqueous electrolyte battery according to [1] or [2], an average particle size Dv₅₀ being from 3 to 35 μm;
[4] the carbonaceous material for a non-aqueous electrolyte battery according to any one of [1] to [3], a ratio Dv₉₀/Dv₁₀ being from 1.05 to 3.00;
[5] the carbonaceous material for a non-aqueous electrolyte secondary battery according to [4], the adjustment of the ratio Dv₉₀/Dv₁₀ to 1.05 to 3.00 being performed by pulverization;
[6] a carbonaceous material for a non-aqueous electrolyte battery having a true density of 1.4 to 1.7 g/cm³, an atom ratio (H/C) of hydrogen atoms to carbon atoms of at most 0.1, as determined by elemental analysis, an average particle size Dv₅₀ of 3 to 35 μm, and a ratio Dv₉₀/Dv₁₀ of 1.05 to 3.00; the carbonaceous material for a non-aqueous electrolyte battery being obtained by: (a) pulverizing a heat-infusible carbon precursor and then subjecting the carbon precursor to final heat treatment at a temperature of 900 to 1600° C.; or (b) subjecting a heat-infusible carbon precursor to final heat treatment at a temperature of 900 to 1600° C. and then pulverizing the carbon precursor;
[7] the carbonaceous material for a non-aqueous electrolyte secondary battery according to any one of [1] to [6], the carbon precursor being at least one selected from the group consisting of infusible petroleum pitch or tar, infusible coal pitch or tar, plant-derived organic materials, infusible thermoplastic resins, and thermosetting resins;
[8] a production method for a carbonaceous material for a non-aqueous electrolyte secondary battery negative electrode, the production method comprising the steps of: (a) pulverizing a heat-infusible carbon precursor and then adjusting the ratio Dv₉₀/Dv₁₀ of the resulting carbonaceous material for a non-aqueous electrolyte secondary battery negative electrode to a range of 1.05 to 3.00; and (b) subjecting a carbon precursor to final heat treatment at 900 to 1600° C.;
[9] the production method for a carbonaceous material for a non-aqueous electrolyte secondary battery negative electrode according to [8], the production method including a step of (c) pre-heat treatment the carbon precursor at a temperature of at least 300° C. and less than 900° C. prior to the step (a) of pulverizing;
[10] the production method for a carbonaceous material for a non-aqueous electrolyte secondary battery negative electrode according to [8] or [9], the carbon precursor being a petroleum pitch or tar, a coal pitch or tar, or a thermoplastic resin; and the production method including a step of (d) infusibilizing a carbonaceous precursor prior to step (c);
[11] the production method for a carbonaceous material for a non-aqueous electrolyte secondary battery negative electrode according to [8] or [9], the carbon precursor being plant-derived organic materials or a thermosetting resin;
[12] a negative electrode for a non-aqueous electrolyte secondary battery containing the carbonaceous material described in any one of [1] to [7];
[13] the negative electrode for a non-aqueous electrolyte secondary battery according to [12], an active material density being from 0.85 to 1.00 g/cc when a pressing pressure of 588 MPa (6.0 t/cm²) is applied;
[14] the negative electrode for a non-aqueous electrolyte secondary battery according to [12], the electrode density being from 0.87 to 1.12 g/cc when a pressing pressure of 588 MPa (6.0 t/cm²) is applied; and
[15] a non-aqueous electrolyte secondary battery having the negative electrode described in any one of [12] to [14].

### Advantageous Effects of Invention

With the carbonaceous material for a non-aqueous electrolyte secondary battery according to the present invention, it is possible to produce a non-aqueous electrolyte secondary battery which exhibits excellent cycle characteristics while maintaining sufficient output characteristics by using the material in a negative electrode for a non-aqueous electrolyte secondary battery (for example, a lithium-ion secondary battery). In addition, with the production method for a carbonaceous material for a non-aqueous electrolyte secondary battery according to the present invention, it is possible to easily produce a carbonaceous material for a negative electrode for a non-aqueous electrolyte secondary battery having excellent output characteristics and cycle characteristics. The fact that the non-aqueous electrolyte secondary battery using the carbonaceous material for a non-aqueous electrolyte secondary battery of the present invention as a material for a negative electrode exhibits excellent output characteristics means that the battery simultaneously exhibits excellent input characteristics.

The mechanism by which a non-aqueous electrolyte secondary battery using the carbonaceous material of the present invention exhibits excellent output characteristics and cycle characteristics has not been specifically determined. However, the carbonaceous material of the present invention is able to yield excellent output characteristics and cycle characteristics by controlling the degree of circularity to 0.50 to 0.95 by means of pulverization or pulverization and classification. In particular, it is possible to achieve excellent output characteristics and cycle characteristics by controlling the ratio Dv₉₀/Dv₁₀, which is an index indicating the distribution width of the particle size distribution, to 1.05 to 3.00 and controlling the degree of circularity to 0.50 to 0.95.

Since a non-aqueous electrolyte secondary battery using the carbonaceous material for a negative electrode according to the present invention has excellent output characteristics and cycle characteristics, the battery is useful for hybrid electric vehicles (HEV) and electric vehicles (EV), which require long life and high input/output characteristics. In particular, the battery is useful as a negative electrode material for a non-aqueous electrolyte secondary battery for hybrid electric vehicles (HEV), which are repeatedly charged and discharged with high frequency and require particularly favorable input/output characteristics.

Furthermore, with the negative electrode for a non-aqueous electrolyte secondary battery of the present invention exhibiting a specific active material density or electrode density when a specific pressing pressure is applied, it is possible to produce a non-aqueous electrolyte secondary battery which maintains charge/discharge efficiency and exhibits excellent output characteristics.

A non-aqueous electrolyte secondary battery using the negative electrode for a non-aqueous electrolyte secondary battery according to the present invention has excellent output characteristics, so the battery is useful for hybrid electric vehicles (HEV), which require higher input/output characteristics.

The fact that the non-aqueous electrolyte secondary battery using the negative electrode for a non-aqueous electrolyte secondary battery according to the present invention exhibits excellent output characteristics means that the battery simultaneously exhibits excellent input characteristics.

### BRIEF DESCRIPTION OF THE DRAWINGS

FIG. 1 is a graph illustrating the particle size distribution of the carbonaceous materials obtained in Working Example 1, Working Example 2, Comparative Example 2, and Comparative Example 8.

FIG. 2 is a graph illustrating the active material density of an electrode when the carbonaceous materials obtained in Working Examples 1 to 4 and Comparative Examples 2 and 7 are pressed with a pressing pressure of 2.5 t/cm², 3 t/cm², 4 t/cm², 5 t/cm², or 6 t/cm².

FIG. 3 is a graph illustrating the electrode density of an electrode when the carbonaceous materials obtained in Working Examples 1 to 4 and Comparative Examples 2 and 7 are pressed with a pressing pressure of 2.5 t/cm², 3 t/cm², 4 t/cm², 5 t/cm², or 6 t/cm².

### DESCRIPTION OF EMBODIMENTS

### [1] Carbonaceous Material for a Non-Aqueous Electrolyte Secondary Battery

The carbonaceous material for a non-aqueous electrolyte secondary battery according to the present invention has an atom ratio (H/C) of hydrogen atoms to carbon atoms of at most 0.1, as determined by elemental analysis, and a degree of circularity of 0.50 to 0.95, and preferably a true density of 1.4 to 1.7 g/cm³, an atom ratio (H/C) of hydrogen atoms to carbon atoms of at most 0.1, as determined by elemental analysis, an average particle size Dv₅₀ (μm) of 3 to 35 μm, a ratio Dv₉₀/Dv₁₀ of 1.05 to 3.00, and a degree of circularity of 0.50 to 0.95.

### <H/C Ratio>

The H/C ratio was determined by measuring hydrogen atoms and carbon atoms by elemental analysis. Since the hydrogen content of the carbonaceous material decreases as the degree of carbonization increases, the H/C ratio tends to decrease. Accordingly, the H/C ratio is effective as an index expressing the degree of carbonization. The H/C ratio of the carbonaceous material of the present invention is at most 0.1 and preferably at most 0.08. The H/C ratio is particularly preferably at most 0.05. When the H/C ratio of hydrogen atoms to carbon atoms exceeds 0.1, the amount of functional groups present in the carbonaceous material increases, and the irreversible capacity increases due to a reaction with lithium.

### <Degree of Circularity>

The degree of circularity of the carbonaceous material of the present invention is from 0.50 to 0.95, preferably from 0.60 to 0.88, and even more preferably from 0.65 to 0.80. A carbonaceous material having a degree of circularity exceeding 0.95 is often a spherical carbonaceous material, so it is not possible to achieve sufficient cycle characteristics, as described in the comparative examples. A carbonaceous material having a degree of circularity of less than 0.50 has a very high aspect ratio, which may lead to anisotropy in the electrodes.

The degree of circularity is specifically calculated from a particle image projected onto a two-dimensional plane. An image of particles is captured with an optical microscope or the like, and the degree of circularity is determined by analyzing the image of the photographed particles. The degree of circularity of particles refers to a value determined by dividing the circumference of a corresponding circle having the same projection area as the particle projection image by the circumference of the particle projection image. For example, the degree of circularity of a particle is 0.952 for a regular hexagon, 0.930 for a regular pentagon, 0.886 for a regular tetragon, and 0.777 for a regular triangle.

### <Average Particle Size>

The average particle size (Dv₅₀) of the carbonaceous material for a non-aqueous electrolyte secondary battery according to the present invention is not particularly limited but is preferably from 3 to 35 μm. When the average particle size is less than 3 μm, the fine powder increase and the specific surface area increases. The reactivity with an electrolyte solution increases, and the irreversible capacity, which is a capacity that is charged but not discharged, also increases, and the percentage of the positive electrode capacity that is wasted thus increases. Thus, this is not preferable. In addition, when producing a negative electrode, each gap formed between the carbonaceous materials becomes small, and the movement of lithium in the electrolyte solution is suppressed, which is not preferable. The lower limit of the average particle size is preferably at least 3 μm, more preferably at least 5 μm, and particularly preferably at least 7 μm. On the other hand, when the average particle size exceeds 35 μm, the diffusion free path of lithium within particles increases, which makes rapid charging and discharging difficult. Furthermore, in the case of a lithium-ion secondary battery, increasing the electrode area is important for improving the input/output characteristics, so it is necessary to reduce the coating thickness of the active material on the current collector at the time of electrode preparation. In order to reduce the coating thickness, it is necessary to reduce the particle size of the active material. From this perspective, the upper limit of the average particle size is preferably at most 35 μm, more preferably at most 25 μm, and particularly preferably at most 20 μm.

### <Particle Size Distribution>

The particle size distribution of the carbonaceous material for a non-aqueous electrolyte secondary battery according to the present invention is not particularly limited but is narrow in comparison to that of conventional carbonaceous materials. It is thought that the sufficient output characteristics can be obtained due to this. Specifically, the ratio Dv₉₀/Dv₁₀ can be used as an index of the particle size distribution, and the lower limit of the ratio Dv₉₀/Dv₁₀ of the carbonaceous material for a non-aqueous electrolyte secondary battery according to the present invention is 1.05, more preferably 1.1, even more preferably 1.2, and most preferably 1.3. In addition, the upper limit of the ratio Dv₉₀/Dv₁₀ is at most 3.00, more preferably 2.8, and most preferably 2.5. When the ratio Dv₉₀/Dv₁₀ exceeds 3.0, the particle size distribution becomes wide, and the negative electrode of the non-aqueous electrolyte secondary battery is densely filled with the carbonaceous material. Accordingly, there are few gaps between the active materials (carbonaceous materials), and it may not be possible to achieve sufficient output characteristics (rate characteristics). In addition, when the ratio Dv₉₀/Dv₁₀ is less than 1.05, the production of the carbonaceous material may become difficult.

For example, although it is also possible to narrow the particle size distribution by means of pulverization, it is preferable to narrow the particle size distribution by means of classification after pulverization. That is, whereas the ratio Dv₉₀/Dv₁₀ can be set to 1.05 to 3.00 by pulverization alone, it is preferable to set the ratio Dv₉₀/Dv₁₀ to 1.05 to 3.00 by means of pulverization and classification. The pulverizer used for pulverization is not particularly limited, and a jet mill, a rod mill, a vibratory ball mill, or a hammer mill, for example, can be used, but a jet mill equipped with a classifier is preferable.

### <True Density>

The true density of a graphitic material having an ideal structure is 2.2 g/cm³, and the true density tends to decrease as the crystal structure becomes disordered. Accordingly, the true density can be used as an index expressing the carbon structure. The true density of the carbonaceous material of the present invention is not particularly limited but is preferably from 1.4 to 1.7 g/cm³ and more preferably from 1.45 to 1.60 g/cm³. The true density is even more preferably from 1.45 to 1.55 g/cm³. A carbonaceous material having a true density exceeding 1.7 g/cm³ has a small number of pores of a size capable of storing lithium, and the doping and de-doping capacity is also small. Thus, this is not preferable. In addition, increases in true density involve the selective orientation of the carbon hexagonal plane, so the carbonaceous material often undergoes expansion and contraction at the time of lithium doping and de-doping, which is not preferable. On the other hand, a carbon material having a true density of less than 1.4 g/cm³ may have a large number of closed pores, and the doping and de-doping capacity may be reduced, which is not preferable. Furthermore, the electrode density decreases and thus causes a decrease in the volume energy density, which is not preferable.

### <Average Interlayer Spacing of the (002) Plane Measured by Powder X-Ray Diffraction>

The average interlayer spacing of the (002) plane of a carbonaceous material indicates a value that decreases as the crystal perfection increases. The spacing of an ideal graphite structure yields a value of 0.3354 nm, and the value tends to increase as the structure is disordered. Accordingly, the average interlayer spacing is effective as an index indicating the carbon structure. The carbonaceous material of the present invention is a non-graphitizable carbonaceous material, and the average interlayer spacing of the (002) plane measured by X-ray diffraction is at least 0.365 nm and at most 0.40 nm, and more preferably at least 0.370 nm and at most 0.400 nm. The average interlayer spacing is particularly preferably at least 0.375 nm and at most 0.400 nm. A small average interlayer spacing of less than 0.365 nm yields a crystal structure characteristic to graphitizable carbon with a developed graphite structure or a graphitic material prepared by treating the graphitizable carbon at a high temperature, and the cycle characteristics are poor, which is not preferable.

### <Pulverization>

The carbonaceous material of the present invention is preferably a carbonaceous material prepared by pulverizing and heat-treating a heat-infusible carbon precursor. That is, the surface structure of carbon changes as a result of being pulverized, and a non-aqueous electrolyte secondary battery using the carbonaceous material of the present invention can thus exhibit excellent cycle characteristics.

The average particle size distribution of the carbonaceous material for a non-aqueous electrolyte secondary battery according to the present invention can be narrowed by means of pulverization and then classification. In this specification, pulverization also includes the classification operation. That is, the ratio Dv₉₀/Dv₁₀ can be set to 1.05 to 3.00 by pulverization and classification.

The pulverizer used for pulverization is not particularly limited, and a jet mill, a rod mill, a ball mill, or a hammer mill, for example, can be used, but a jet mill equipped with a classifier is preferable.

In addition, the ratio Dv₉₀/Dv₁₀ of the negative electrode material for a non-aqueous electrolyte secondary battery ultimately obtained by pulverization and classification can be adjusted to the range of 1.05 to 3.00. However, the particle size of the carbon precursor decreases due to heat treatment, so it is preferable to adjust the ratio Dv₉₀/Dv₁₀ of the negative electrode material for a non-aqueous electrolyte secondary battery that is ultimately obtained to the range of 1.05 to 3.00 by adjusting the particle size to a slightly large particle size at the production stage.

Classification is an operation of selecting a group of particles having a particle size distribution within a certain range from groups of particles of various mixed particle sizes. In the present invention, no particular limitations are placed on the method of classification, but classification with a sieve, wet classification, and dry classification can be given as examples of typically used classification methods. An example of a wet classifier is a classifier utilizing a principle such as gravitational classification, inertial classification, hydraulic classification, or centrifugal classification. In addition, an example of a dry classifier is a classifier utilizing a principle such as sedimentation classification, mechanical classification, or centrifugal classification.

The ratio Dv₉₀/Dv₁₀ can be set to 1.05 to 3.00 by the pulverization and classification described above.

The classifier that is used may be independent from the pulverizer, but a classifier connected to the pulverizer may also be used. For example, when pulverization is performed with a ball mill, a hammer mill, or a rod mill, a negative electrode material for a non-aqueous electrolyte secondary battery with a ratio Dv₉₀/Dv₁₀ of 1.05 to 3.00 can be obtained by classifying the pulverized carbon precursor with a classifier. Pulverization and classification may also be performed using a jet mill equipped with a dry classification function.

In addition, the ratio Dv₉₀/Dv₁₀ of the negative electrode material for a non-aqueous electrolyte secondary battery ultimately obtained by pulverization and classification can be adjusted to the range of 1.05 to 3.00. However, the particle size of the carbon precursor decreases due to heat treatment, so it is preferable to adjust the ratio Dv₉₀/Dv₁₀ of the negative electrode material for a non-aqueous electrolyte secondary battery that is ultimately obtained to the range of 1.05 to 3.00 by adjusting the particle size to a slightly large particle size at the production stage.

The timing of pulverization is not limited as long as the effect of the present invention can be achieved. In the case of a heat-fusible carbon precursor, for example, it is possible to pulverize the carbon precursor after infusibilization and to then perform pre-heat treatment and final heat treatment, or final heat treatment alone. It is also possible to perform pulverization and final heat treatment after infusibilization and pre-heat treatment. The carbon precursor may also be pulverized after final heat treatment. In particular, the carbon precursor can be transformed to a heat-infusible carbon precursor by a heat treatment in an oxidizing, non-oxidizing, or mixed gas atmosphere at a temperature of 200 to 900° C., and the timing of pulverization is preferably after this heat treatment is performed. When pre-heat treatment (or infusibilization and pre-heat treatment) is performed after pulverization, the surface of the resulting carbonaceous material may become smooth. From the perspective of exhibiting the effect of the present invention, it is preferable for the surface of the carbonaceous material of the present invention to be irregular.

In the case of a heat-infusible carbon precursor that does not require infusibilization treatment, it is possible to perform pulverization and then pre-heat treatment and final heat treatment or final heat treatment alone. It is also possible to perform pulverization and final heat treatment after pre-heat treatment. The carbon precursor may also be pulverized after final heat treatment.

### <Carbon Precursor>

The carbonaceous material of the present invention is produced from a carbon precursor. Examples of carbon precursors include petroleum pitch or tar, coal pitch or tar, plant-derived organic material, thermoplastic resins, and thermosetting resins. Examples of the plant-derived organic material include coconut shells, coffee beans, tea leaves, sugar cane, fruits (tangerines or bananas), straw, broad-leaved trees, coniferous trees, bamboo, and rice hulls. These types of plant-derived organic material contain many impurities other than carbon, hydrogen, and oxygen such as alkali metals and alkali earth metals, so it is preferable for the amount of impurities to be small. The amount of impurities of the carbonaceous material of the present invention prepared using these as raw materials is preferably at most 1 wt. %, more preferably at most 0.5 wt. %, and even more preferably at most 0.1 wt. %. The process of performing a de-mineral operation is not particularly limited but is preferably performed prior to final heat treatment. In addition, examples of thermoplastic resins include polyacetals, polyacrylonitriles, styrene/divinylbenzene copolymers, polyimides, polycarbonates, modified polyphenylene ethers, polybutylene terephthalates, polyarylates, polysulfones, polyphenylene sulfides, fluorine resins, polyamide imides, and polyether ether ketones. Furthermore, examples of thermosetting resins include phenol resins, amino resins, unsaturated polyester resins, diallyl phthalate resins, alkyd resins, epoxy resins, and urethane resins.

In this specification, a “carbon precursor” refers to a carbon material from the stage of an untreated carbon material to the preliminary stage of the carbonaceous material for a non-aqueous electrolyte secondary battery that is ultimately obtained. That is, a “carbon precursor” refers to all carbon materials for which the final step has not been completed.

In addition, in this specification, a “heat-infusible carbon precursor” refers to a resin that does not melt due to pre-heat treatment or final heat treatment. That is, in the case of petroleum pitch or tar, coal pitch or tar, or a thermoplastic resin, this refers to a carbonaceous precursor subjected to the infusibilization treatment described below. On the other hand, since plant-derived organic material and thermosetting resins do not melt even when the plant-derived organic material and thermosetting resins are subjected to pre-heat treatment or final heat treatment as is, infusibilization treatment is unnecessary.

Since the carbonaceous material of the present invention is a non-graphitizable carbonaceous material, a petroleum pitch or tar, coal pitch or tar, or thermoplastic resin must be subjected to infusibilization treatment in order to make the material heat-infusible in the production process. Infusibilization treatment can be performed by forming a crosslink in the carbon precursor by oxidation. That is, infusibilization treatment can be performed by a publicly known method in the field of the present invention. For example, infusibilization treatment can be performed in accordance with the infusibilization (oxidation) procedure described in the “production method for a carbonaceous material for a non-aqueous electrolyte secondary battery negative electrode” described below.

### <Heat Treatment>

Heat treatment is the process of transforming a non-graphitizable carbon precursor into a carbonaceous material for a non-aqueous electrolyte secondary battery negative electrode. In the present invention, heat treatment is preferably performed by pre-heat treatment at a temperature of at least 300° C. and less than 900° C. and final heat treatment at a temperature of 900 to 1600° C. When the pre-heat treatment temperature is too low, de-tarring becomes insufficient, and a large amount of tar is generated at the time of final heat treatment. This causes a decrease in battery performance, which is not preferable. The pre-heat treatment temperature is preferably at least 300° C., more preferably at least 500° C., and particularly preferably at least 600° C. On the other hand, when the pre-heat treatment temperature is too high, the temperature exceeds the tar-generating temperature range, and the used energy efficiency decreases, which is not preferable. Furthermore, the generated tar causes a secondary decomposition reaction, and the tar adheres to the carbon precursor and causes a decrease in performance, which is not preferable. The pulverization step may be performed after the infusibilization step but is preferably performed after pre-heat treatment. When the pre-heat treatment temperature is too high, the carbon precursor becomes hard. This causes the pulverization efficiency to decrease, which is not preferable. Pre-heat treatment is preferably performed at a temperature of at most 900° C. When performing pre-heat treatment and final heat treatment, the carbon precursor may be pulverized and subjected to final heat treatment after the temperature is reduced after pre-heat treatment.

Pre-heat treatment and final heat treatment can be performed by a publicly known method in the field of the present invention. For example, pre-heat treatment and final heat treatment can be performed in accordance with the final heat treatment procedure or the pre-heat treatment and final heat treatment procedures described in the “production method for a carbonaceous material for a non-aqueous electrolyte secondary battery negative electrode” described below.

### [2] Production Method for a Carbonaceous Material for a Non-Aqueous Electrolyte Secondary Battery

The production method for a carbonaceous material for a non-aqueous electrolyte secondary battery negative electrode according to the present invention comprises (a) a step of pulverizing a heat-infusible carbon precursor and (b) a step of subjecting the carbon precursor to final heat treatment at 900 to 1600° C. In the pulverization step, the ratio Dv₉₀/Dv₁₀ of the resulting carbonaceous material for a non-aqueous electrolyte secondary battery negative electrode is adjusted to the range of 1.05 to 3.00. The production method for a carbonaceous material for a non-aqueous electrolyte secondary battery negative electrode according to the present invention preferably includes (c) a step of subjecting the carbon precursor to pre-heat treatment at a temperature of at least 300° C. and less than 900° C. prior to the pulverization step (a). The production method for a carbonaceous material for a non-aqueous electrolyte secondary battery negative electrode according to the present invention is not particularly limited but is a method suitable for obtaining the carbonaceous material for a non-aqueous electrolyte secondary battery negative electrode of any of items [4] to [6] described above.

### <Pre-Heat Treatment Step>

The pre-heat treatment step in the production method of the present invention is performed by heat treatment a carbon source at a temperature of at least 300° C. and less than 900° C. Pre-heat treatment removes volatile matter such as CO₂, COCH₄, and Hz, for example, and the tar content, so that the generation of these components can be reduced and the load of the heat treatment furnace can be reduced in final heat treatment. When the pre-heat treatment temperature is less than 500° C., de-tarring becomes insufficient, and the amount of tar or gas generated in the final heat treatment step after pulverization becomes large. This may adhere to the particle surface and cause a decrease in battery performance without being able to maintain the surface properties after pulverization, which is not preferable. On the other hand, when the pre-heat treatment temperature is 900° C. or higher, the temperature exceeds the tar-generating temperature range, and the used energy efficiency decreases, which is not preferable. Furthermore, the generated tar causes a secondary decomposition reaction, and the tar adheres to the carbon precursor and causes a decrease in performance, which is not preferable. The pulverization step may be performed after the infusibilization step but is preferably performed after preliminary firing. When the pre-heat treatment temperature is too high, carbonization progresses and the particles become too hard. As a result, when pulverization is performed after pre-heat treatment, pulverization may be difficult due to the chipping away of the interior of the pulverizer, which is not preferable.

Pre-heat treatment is performed in an inert gas atmosphere, and examples of inert gases include nitrogen, argon, and the like. In addition, pre-heat treatment can be performed under reduced pressure at a pressure of 10 kPa or less, for example. The pre-heat treatment time is not particularly limited, but pre-heat treatment may be performed for 0.5 to 10 hours, for example, and is preferably performed for 1 to 5 hours.

### <Pulverization Step>

The pulverization step in the production method for a carbonaceous material for a non-aqueous electrolyte secondary battery according to the present invention is performed in order to uniform the particle size of the non-graphitizable carbon precursor. That is, in the pulverization step, the ratio D₉₀/Dv₁₀ of the resulting carbonaceous material for a non-aqueous electrolyte secondary battery negative electrode is adjusted to the range of 1.05 to 3.00. In this specification, the pulverization step includes pulverization and classification, and the adjustment of the ratio Dv₉₀/Dv₁₀ to the range of 1.05 to 3.00 is performed by means of pulverization and classification. Furthermore, an appropriate particle size distribution can be adjusted to the Dv₉₀/Dv₁₀ range of 1.05 to 3.00 by appropriately combining classification, mixing, or the like after pulverization.

The pulverizer used for pulverization is not particularly limited, and a jet mill, a ball mill, a hammer mill, a rod mill, or the like, for example, can be used, but a jet mill equipped with a classification function is preferable from the perspective that there is minimal fine powder generation. On the other hand, when a ball mill, a hammer mill, a rod mill, or the like is used, fine powder can be removed by performing classification after pulverization.

Examples of classification include classification with a sieve, wet classification, and dry classification. An example of a wet classifier is a classifier utilizing a principle such as gravitational classification, inertial classification, hydraulic classification, or centrifugal classification. In addition, an example of a dry classifier is a classifier utilizing a principle such as sedimentation classification, mechanical classification, or centrifugal classification.

In the pulverization step, pulverization and classification can be performed with a single apparatus. For example, pulverization and classification can be performed using a jet mill equipped with a dry classification function.

Furthermore, an apparatus with an independent pulverizer and classifier can also be used. In this case, pulverization and classification can be performed continuously, but pulverization and classification may also be performed non-continuously.

In addition, the particle size is adjusted to a slightly large particle size at the production stage in order to adjust the ratio Dv₉₀/Dv₁₀ of the resulting negative electrode material for a non-aqueous electrolyte secondary battery to the range of 1.05 to 3.00. This is because the particle size of the carbon precursor decreases due to heat treatment.

### <Final Heat Treatment Step>

The final heat treatment step in the production method of the present invention can be performed in accordance with an ordinary final heat treatment procedure, and a carbonaceous material for a non-aqueous electrolyte secondary battery negative electrode can be obtained by performing final heat treatment. The final heat treatment temperature is from 900 to 1600° C. When the final heat treatment temperature is less than 900° C., a large amount of functional groups remain in the carbonaceous material, and the value of H/C increases. The irreversible capacity also increases due to a reaction with lithium, which is not preferable. The lower limit of the final heat treatment temperature in the present invention is at least 900° C., more preferably at least 1000° C., and particularly preferably at least 1100° C. On the other hand, when the final heat treatment temperature exceeds 1600° C., the selective orientation of the carbon hexagonal plane increases, and the discharge capacity decreases, which is not preferable. The upper limit of the final heat treatment temperature in the present invention is at most 1600° C., more preferably at most 1500° C., and particularly preferably at most 1450° C.

Final heat treatment is preferably performed in a non-oxidizing gas atmosphere. Examples of non-oxidizing gases include helium, nitrogen, and argon, and the like, and these may be used alone or as a mixture. Final heat treatment may also be performed in a gas atmosphere in which a halogen gas such as chlorine is mixed with the non-oxidizing gas described above. In addition, final heat treatment can be performed under reduced pressure at a pressure of 10 kPa or less, for example. The final heat treatment time is not particularly limited, but final heat treatment can be performed for 0.1 to 10 hours, for example, and is preferably performed for 0.3 to 8 hours, and more preferably for 0.4 to 6 hours.

### <Infusibilization Step>

Infusibilization treatment is performed when a petroleum pitch or tar, coal pitch or tar, or thermoplastic resin is used as a carbon precursor. The method used for infusibilization treatment is not particularly limited, but infusibilization treatment may be performed using an oxidizer, for example. The oxidizer is also not particularly limited, but an oxidizing gas such as O₂, O₃, SO₃, NO₂, a mixed gas in which these are diluted with air, nitrogen, or the like, or air may be used as a gas. In addition, an oxidizing liquid such as sulfuric acid, nitric acid, or hydrogen peroxide or a mixture thereof can be used as a liquid. The oxidation temperature is also not particularly limited but is preferably from 120 to 400° C. and more preferably from 150 to 350° C. When the temperature is less than 120° C., a crosslinked structure cannot be formed sufficiently, and particles fuse to one another in the heat treatment step. When the temperature exceeds 400° C., decomposition reactions become more prominent than crosslinking reactions, and the yield of the resulting carbon material becomes low.

<Production of a Carbonaceous Material from Tar or Pitch>

Examples of the production method for the carbonaceous material of the present invention from tar or pitch will be described below.

First, the purpose of performing crosslinking treatment (infusibilization) on the tar or pitch is to make the resulting carbonaceous material non-graphitizable by carbonizing the tar or pitch after crosslinking treatment. Examples of tar or pitch that can be used include petroleum or coal tar or pitch such as petroleum tar or pitch produced as a by-product at the time of ethylene production, coal tar produced at the time of coal carbonization, heavy components or pitch from which the low-boiling-point components of coal tar are distilled out, or tar or pitch obtained by coal liquification. Two or more of these types of tar and pitch may also be mixed together.

Specific methods of infusibilization include a method of using a crosslinking agent and a method of treating the material with an oxidizer such as air. When a crosslinking agent is used, a carbon precursor is obtained by adding a crosslinking agent to the petroleum tar or pitch or coal tar or pitch and mixing the substances while heating so as to promote crosslinking reactions. For example, a polyfunctional vinyl monomer with which crosslinking reactions are promoted by radical reactions such as divinylbenzene, trivinylbenzene, diallyl phthalate, ethylene glycol dimethacrylate, or N,N-methylene bis-acrylamide may be used as a crosslinking agent. Crosslinking reactions with the polyfunctional vinyl monomer are initiated by adding a radical initiator. Here, α,α′-azobis-isobutyronitrile (AIBN), benzoyl peroxide (BPO), lauroyl peroxide, cumene hydroperoxide, 1-butyl hydroperoxide, hydrogen peroxide, or the like can be used as a radical initiator.

In addition, when promoting crosslinking reactions by treating the material with an oxidizer such as air, it is preferable to obtain the carbon precursor with the following such method. Specifically, after a 2- or 3-ring aromatic compound with a boiling point of at least 200° C. or a mixture thereof is added to a petroleum or coal pitch as an additive and mixed while stirring, the mixture is molded to obtain a pitch compact. Next, after the additive is extracted from the pitch compact with a solvent having low solubility with respect to the pitch and having high solubility with respect to the additive so as to form a porous pitch, the mixture is oxidized using an oxidizer to obtain a carbon precursor. The purpose of the aromatic additive described above is to make the compact porous by extracting the additive from the pitch compact after molding so as to facilitate crosslinking treatment by means of oxidation and to make the carbonaceous material obtained after carbonization porous. The additive described above may be selected, for example, from one type of naphthalene, methyl naphthalene, phenyl naphthalene, benzyl naphthalene, methyl anthracene, phenanthrene, and biphenyl and a mixture of two or more types thereof. The amount of the aromatic additive added to the pitch is preferably in a range of 30 to 70 parts by weight per 100 parts by weight of the pitch.

The pitch and the additive can be mixed while heating in a melted state in order to achieve a uniform mixture. This is preferably performed after the mixture of the pitch and the additive is molded into particles with a particle size of at most 1 mm so that the additive can be easily extracted from the mixture. Molding may be performed in the melted state and may be performed with a method such as cooling and then pulverizing the mixture. Suitable examples of solvents for extracting the additive from the mixture of the pitch and the additive include aliphatic hydrocarbons such as butane, pentane, hexane, or heptane, mixtures of aliphatic hydrocarbon primary constituents such as naphtha or kerosene, and aliphatic alcohols such as methanol, ethanol, propanol, or butanol. By extracting the additive from the mixture compact of the pitch and the additive with such a solvent, it is possible to remove the additive from the compact while maintaining the shape of the compact. Here, it is presumed that a pitch compact having uniform porosity is obtained as a result of holes for the additive being formed in the compact.

In order to crosslink the obtained porous pitch, the substance is then preferably oxidized using an oxidizer at a temperature of 120 to 400° C. Here, an oxidizing gas such as O₂, O₃, NO₂, a mixed gas in which these are diluted with air, nitrogen, or the like, or air, or an oxidizing liquid such as sulfuric acid, nitric acid, or hydrogen peroxide water can be used as an oxidizer. It is convenient and economically advantageous to perform crosslinking treatment by oxidizing the material at 120 to 400° C. using a gas containing oxygen such as air or a mixed gas of air and another gas such as a combustible gas, for example, as an oxidizer. In this case, when the softening point of the pitch is low, the pitch melts at the time of oxidation, which makes oxidation difficult, so the pitch that is used preferably has a softening point of at least 150° C.

After the carbon precursor subjected to crosslinking treatment as described above is subjected to pre-heat treatment, the carbonaceous material of the present invention can be obtained by carbonizing the carbon precursor at 900° C. to 1600° C. in a non-oxidizing gas atmosphere.

<Production of a Carbonaceous Material from Plant-Derived Organic Material>

Examples of the production method for the carbonaceous material from plant-derived organic material will be described below.

Plant-derived organic matter such as coffee extracts, coconut shells, bamboo, or wood, for example, can be used as a precursor for the carbonaceous material of the present invention. Since the plant-derived carbon precursor contains mineral such as alkali metals or alkali earth metals, it is preferable to use the precursor after removing this mineral. The method for removing mineral is not particularly limited, but the mineral can be removed using an acid. When the precursor is carbonized at 900° C. to 1600° C. in a state containing plant-derived mineral, the mineral in carbonaceous material reacts and causes a decrease in battery performance, which is not preferable. Therefore, the removal of mineral is preferably performed prior to the carbonization step. In addition, the amount of impurities in the carbonaceous material prepared from a plant-derived carbon precursor is preferably as low as possible. The content of potassium, which is a representative element contained in plants, is preferably at most 0.5 wt. %, more preferably at most 0.1 wt. %, and particularly preferably at most 0.05 wt. %. Since the plant-derived carbon precursor does not melt even when subjected to heat treatment, the order of the pulverization step is not particularly limited. The step can be performed prior to pre-heat treatment, after pre-heat treatment and before final heat treatment, or after final heat treatment, but since the plant-derived carbon precursor produces a large amount of pyrolysis products due to heat treatment, the pulverization step is preferably performed after removing the pyrolysis products by pre-heat treatment in order to control the particle size distribution. When the pre-heat treatment temperature is too high, the particles harden, which is not preferable in that pulverization becomes difficult. When the temperature is too low, the removal of pyrolysis products is incomplete, which is not preferable. The pre-heat treatment temperature is preferably from 300° C. to 900° C., more preferably from 400° C. to 900° C., and particularly preferably from 500° C. to 900° C. The carbonaceous material of the present invention can be prepared by appropriately combining [1] a de-mineral step, [2] a pre-heat treatment step as necessary, [3] a pulverization step, and [4] a final heat treatment step for the plant-derived carbon precursor.

<Production of a Carbonaceous Material from a Resin>

Examples of the production method for the carbonaceous material from a resin will be described below.

The carbonaceous material of the present invention can also be obtained by carbonizing the material at 900° C. to 1600° C. using a resin as a precursor. Phenol resins, furan resins, or thermosetting resins in which the functional groups of these resins are partially modified may be used as resins. The carbonaceous material can also be obtained by subjecting a thermosetting resin to pre-heat treatment at a temperature of at most 900° C. as necessary and then pulverizing and carbonizing the resin at 900° C. to 1600° C. Oxidation treatment (infusibilization treatment) may also be performed as necessary at a temperature of 120 to 400° C. for the purpose of accelerating the curing of the thermosetting resin, accelerating the degree of crosslinkage, or improving the carbonization yield. Here, an oxidizing gas such as O₂, O₃, NO₂, a mixed gas in which these are diluted with air, nitrogen, or the like, or air, or an oxidizing liquid such as sulfuric acid, nitric acid, or hydrogen peroxide water can be used as an oxidizer. The pulverization step may also be performed after carbonization, but when the carbonization reaction progresses, the carbon precursor becomes hard, which makes it difficult to control the particle size distribution by means of pulverization, so the pulverization step is preferably performed after pre-heat treatment at a temperature of at most 900° C. and prior to final heat treatment.

Furthermore, it is also possible to use a carbon precursor prepared by infusibilizing a thermoplastic resin such as polyacrylonitrile or a styrene/divinyl benzene copolymer. These resins can be obtained, for example, by adding a monomer mixture prepared by mixing a radical polymerizable vinyl monomer and a polymerization initiator to an aqueous dispersion medium containing a dispersion stabilizer, suspending the mixture by mixing while stirring to transform the monomer mixture to fine liquid droplets, and then heating the droplets to promote radical polymerization. The resulting crosslinking structure of the resin can be developed by means of infusibilization treatment to form a spherical carbon precursor. Oxidation treatment can be performed in a temperature range of 120 to 400° C., particularly preferably in a range of 170 to 350° C., and even more preferably in a range of 220 to 350° C. Here, an oxidizing gas such as O₂, O₃, SO₃, NO₂, a mixed gas in which these are diluted with air, nitrogen, or the like, or air, or an oxidizing liquid such as sulfuric acid, nitric acid, or hydrogen peroxide water can be used as an oxidizer. The carbonaceous material of the present invention can be obtained by then subjecting the heat-infusible carbon precursor to pre-heat treatment as necessary, as described above and then pulverizing and carbonizing the carbon precursor at 900° C. to 1600° C. in a non-oxidizing gas atmosphere. The pulverization step may also be performed after carbonization, but when the carbonization reaction progresses, the carbon precursor becomes hard, which makes it difficult to control the particle size distribution by means of pulverization, so the pulverization step is preferably performed after pre-heat treatment at a temperature of at most 900° C. and prior to final heat treatment.

### [3] Negative Electrode for a Non-Aqueous Electrolyte Secondary Battery

The negative electrode for a non-aqueous electrolyte secondary battery according to the present invention is not particularly limited as long as the negative electrode uses the carbonaceous material for a non-aqueous electrolyte secondary battery according to the present invention.

One mode of the negative electrode for a non-aqueous electrolyte secondary battery according to the present invention contains a carbonaceous material having an atom ratio (H/C) of hydrogen atoms to carbon atoms of at most 0.1, as determined by elemental analysis, and a degree of circularity of 0.50 to 0.95 as a negative electrode active material, wherein the active material density is from 0.85 to 1.00 g/cc when a pressing pressure of 588 MPa (6.0 t/cm²) is applied.

Another mode of the negative electrode for a non-aqueous electrolyte secondary battery according to the present invention may contain a carbonaceous material having an atom ratio (H/C) of hydrogen atoms to carbon atoms of at most 0.1, as determined by elemental analysis, and a degree of circularity of 0.50 to 0.95 as a negative electrode active material, wherein the electrode density is from 0.87 to 1.12 g/cc when a pressing pressure of 588 MPa (6.0 t/cm²) is applied.

Furthermore, the carbonaceous material used in the negative electrode for a non-aqueous electrolyte secondary battery according to the present invention preferably has at least one of the following characteristics: the true density is from 1.4 to 1.7 g/cm³, the average particle size Dv₅₀ is from 3 to 35 μm, and the ratio Dv₉₀/Dv₁₀ is from 1.05 to 3.00.

The negative electrode for a non-aqueous electrolyte secondary battery according to the present invention can be produced based on ordinary knowledge in this technical field as long as the active material density is from 0.85 to 1.00 g/cc or the electrode density is from 0.87 to 1.12 g/cc when a pressing pressure of 588 MPa (6.0 t/cm²) is applied. That is, the negative electrode for a non-aqueous electrolyte secondary battery according to the present invention may contain a non-graphitizable carbonaceous material and a binder as well as a conductivity agent. Non-graphitizable carbonaceous materials, binders, conductivity agents, and solvents that can be used in the negative electrode for a non-aqueous electrolyte secondary battery according to the present invention will be described hereinafter, and the active material density and electrode density of the negative electrode for a non-aqueous electrolyte secondary battery will also be described.

### <Non-Graphitizable Carbonaceous Material>

The non-graphitizable carbonaceous materials that can be used in the negative electrode for a non-aqueous electrolyte secondary battery according to the present invention are not particularly limited as long as the material is the carbonaceous material for a non-aqueous electrolyte secondary battery according to the present invention, but the material preferably has an active material density of 0.85 to 1.00 g/cc when a pressing pressure of 588 MPa (6.0 t/cm²) is applied or an electrode density of 0.87 to 1.12 g/cc when a pressing pressure of 588 MPa (6.0 t/cm²) is applied.

### <Binder>

The negative electrode for a non-aqueous electrolyte secondary battery may contain a binder. The binders that can be used in the present invention are not particularly limited as long as the binders do not react with electrolyte solutions, and examples of binders that do not react with electrolyte solutions include polyvinylidene fluoride (PVDF), polytetrafluoroethylene, styrene-butadiene rubber (SBR), polyacrylonitrile (PAN), ethylene-propylene-diene copolymers (EPDM), fluorine rubber (FR), acrylonitrile-butadiene rubber (NBR), sodium polyacrylate, propylene, and carboxymethylcellulose (CMC). Of these, PVDF is preferable in that the PVDF adhering to the active material surface minimally inhibits lithium ion movement and in that favorable input/output characteristics can be achieved. A polar solvent such as N-methylpyrrolidone (NMP) is preferably used to dissolve PVDF and form a slurry, but an aqueous emulsion such as SBR or CMC may also be dissolved in water. The preferable amount of the binder that is added differs depending on the type of the binder that is used. In the case of a PVDF-type binder, the added amount is preferably from 3 to 13 wt. % and more preferably from 3 to 10 wt. % (here, it is assumed that the amount of the active material (carbonaceous material)+the amount of binder+the amount of the conductivity aid=100 wt. %). On the other hand, in the case of a binder using water as a solvent, a plurality of binders such as a mixture of SBR and CMC are often used in combination, and the total amount of all of the binders that are used is preferably from 0.5 to 5 wt. % and more preferably from 1 to 4 wt. %. When the added amount of the binder is too large, the electrical resistance of the resulting electrode becomes high, and the internal resistance of the battery becomes high. This diminishes the battery characteristics, which is not preferable. When the added amount of the binder is too small, the bonds between the non-graphitizable carbonaceous materials (negative electrode active material particles) and the current collector becomes insufficient, which is not preferable. The electrode active material layer is typically formed on both sides of the current collector, but the layer may be formed on one side as necessary. The amount of required current collectors or separators becomes smaller as the thickness of the electrode active material layer increases, which is preferable for increasing capacity. However, it is more advantageous from the perspective of improving the input/output characteristics for the electrode area of opposite electrodes to be wider, so when the active material layer is too thick, the input/output characteristics are diminished, which is not preferable. The thickness of the active material layer (on each side) is preferably from 10 to 100 μm, more preferably from 20 to 75 μm, and particularly preferably from 20 to 60 μm.

### <Conductivity Agent>

An electrode having high conductivity can be produced by using the carbonaceous material of the present invention without particularly adding a conductivity agent, but a conductivity agent may be added as necessary when preparing the electrode mixture for the purpose of imparting even higher conductivity. That is, although a negative electrode for a non-aqueous electrolyte secondary battery can also be produced with a non-graphitizable carbonaceous material (carbon negative electrode active material) and a binder alone, a negative electrode for a non-aqueous electrolyte secondary battery can also be produced by adding a conductivity agent. Conductive carbon black, vapor growth carbon fiber (VGCF (registered trademark)), carbon nanotubes, or the like can be used as a conductivity agent. The added amount of the conductivity agent differs depending on the type of the conductivity agent that is used, but when the added amount is too small, the expected conductivity cannot be achieved, which is not preferable. Conversely, when the added amount is too large, the dispersion of the conductivity agent in the electrode mixture becomes poor, which is not preferable. From this perspective, the proportion of the added amount of the conductivity agent is preferably from 0.5 to 10 wt. % (here, it is assumed that the active material (carbonaceous material)+the amount of the binder+the amount of the conductivity aid=100 wt. %), more preferably from 0.5 to 7 wt. %, and particularly preferably from 0.5 to 5 wt. %.

### <Solvents>

When producing the negative electrode for a non-aqueous electrolyte secondary battery according to the present invention, a solvent is added and kneaded into the non-graphitizable carbonaceous material, the binder, and the like. Any solvent that is used at the time of the production of a negative electrode for a non-aqueous electrolyte secondary battery can be used without limitation. A specific example is N-methylpyrrolidone (NMP). For example, in the case of polyvinylidene fluoride, a polar solvent such as N-methylpyrrolidone (NMP) is preferably used, and an aqueous emulsion such as SBR may also be used.

### <Production of a Negative Electrode for a Non-Aqueous Electrolyte Secondary Battery>

The negative electrode for a non-aqueous electrolyte secondary battery according to the present invention is not particularly limited but may be produced as follows, for example.

First, 1 to 10 parts by weight of polyvinylidene fluoride are added as a binder to 100 parts by weight of a non-graphitizable carbonaceous material, and an appropriate amount of N-methylpyrrolidone is further added and kneaded. Alternatively, 1 to 15 parts by weight of polyvinylidene fluoride as a binder and 0.5 to 15 parts by weight of acetylene black as a conductivity agent are added to 100 parts by weight of a non-graphitizable carbonaceous material, and an appropriate amount of N-methylpyrrolidone is further added and kneaded. The resulting electrode mixture paste is applied to a conductive current collector such as a circular or rectangular metal sheet. The electrode mixture paste that is applied is dried by applying heat. The dried electrode mixture paste is compression-molded to form a layer with a thickness of preferably 20 to 100 μm and more preferably 20 to 75 μm, and this is used as a negative electrode.

The compression molding of the negative electrode for a non-aqueous electrolyte secondary battery according to the present invention can be performed, for example, with a plate pressing machine or a roll pressing machine. The pressing pressure is not particularly limited but is preferably from 98 MPa (1.0 t/cm²) to 980 MPa (10 t/cm²) and more preferably from 245 MPa (2.5 t/cm²) to 784 MPa (8 t/cm²). When the pressing pressure is 98 MPa or greater, the contact between the non-graphitizable carbonaceous materials (active materials) improves, and the charge/discharge efficiency is improved as a result.

In addition, although not particularly limited, in the negative electrode for a non-aqueous electrolyte secondary battery according to the present invention, the active material density can be controlled to within an optimal range by setting the pressing pressure to at least 98 MPa. That is, when the active material density is too high in the negative electrode, the gaps between the active materials of the electrode become small, and the output characteristics are diminished. On the other hand, when the active material density is too low, the contact between the active substances becomes poor, and the conductivity is reduced, which decreases the energy density per unit volume. The negative electrode for a non-aqueous electrolyte secondary battery according to the present invention can achieve an optimal active material density when subjected to a pressing pressure of at least 98 MPa (1.0 t/cm²).

### (Production Method for a Negative Electrode for a Non-Aqueous Electrolyte Secondary Battery)

The negative electrode for a non-aqueous electrolyte secondary battery can be produced by applying a pressing pressure of at least 49 MPa (0.5 t/cm²), for example, to a mixture containing a carbonaceous material and a binder, the carbonaceous material having an atom ratio (H/C) of hydrogen atoms to carbon atoms of at most 0.1, as determined by elemental analysis, a degree of circularity of 0.50 to 0.95, and a ratio Dv₉₀/Dv₁₀ of 1.05 to 3.00.

### (Active Material Density)

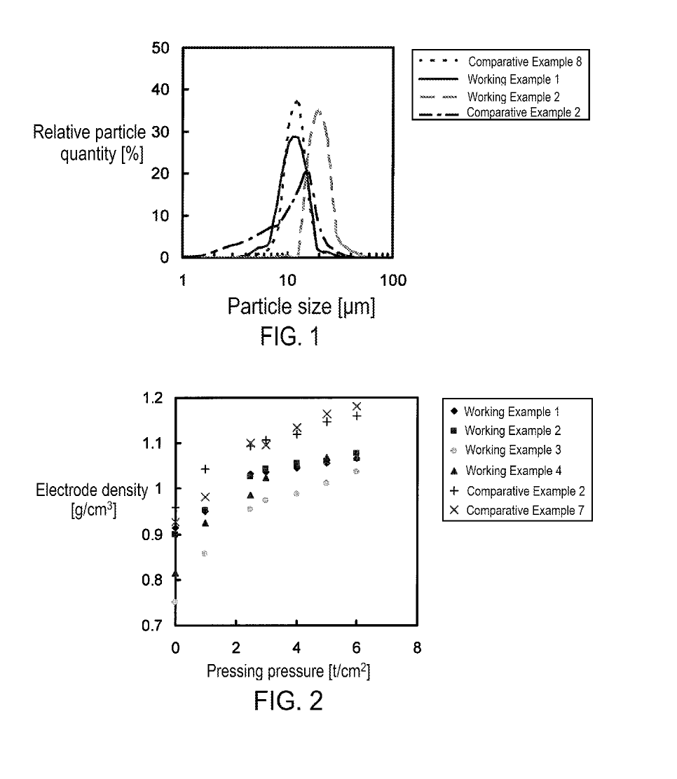

The negative electrode for a non-aqueous electrolyte secondary battery according to the present invention is characterized by using a carbonaceous material for a non-aqueous electrolyte secondary battery having an atom ratio (H/C) of hydrogen atoms to carbon atoms of at most 0.1, as determined by elemental analysis, and a degree of circularity of 0.50 to 0.95, wherein the active material density is from 0.85 to 1.00 g/cc when a pressing pressure of 588 MPa (6.0 t/cm²) is applied. When the active material density is less than 0.85 g/cc, this causes a decrease in the volume energy density, which is not preferable. On the other hand, when the active material density exceeds 1.00 g/cc, the gaps formed between the active materials become small, and the movement of lithium in the electrolyte solution is suppressed, which is not preferable. The upper limit of the active material density is preferably at most 1.00 g/cc and more preferably at most 0.96 g/cc when a pressing pressure of 588 MPa (6.0 t/cm²) is applied. As illustrated in FIG. 1, the negative electrodes for a non-aqueous electrolyte secondary battery according to the present invention (Working Examples 5 to 8) demonstrate a minimal increase in active material density when a pressing pressure of at least 245 MPa (2.5 t/cm²) is applied, even when the pressing pressure increases. On the other hand, conventional negative electrodes for a non-aqueous electrolyte secondary battery (Comparative Examples 10 and 15) demonstrate increases in active material density in step with increases in the pressing pressure. That is, the active material density of the conventional negative electrodes for a non-aqueous electrolyte secondary battery exceeds 1.00 g/cc when a pressing pressure of 588 MPa (6.0 t/cm²) is applied. In this way, a negative electrode for a non-aqueous electrolyte secondary battery with an increasing active material density has low output characteristics (capacity retention in rapid discharge tests). On the other hand, the negative electrode for a non-aqueous electrolyte secondary battery, which demonstrates minimal increases in active material density, has excellent output characteristics (capacity retention in rapid discharge tests).

The active material density can be calculated as follows.

Active material density[g/cm³]=(W₂/S−W₁)/(t₂−t₁)×P

The negative electrode is produced by applying a mixture of a graphite compound, which has a mass ratio of P in the carbonaceous material, and a binder to a current collector having a thickness of t₁ [cm] and a mass per unit area of W₁ [g/cm²] and punching out the produced negative electrode having a thickness of t₂ [cm] with a prescribed area S [cm²] by applying pressure, wherein the mass of the negative electrode after punching is defined as W₂ [g].

### (Electrode Density)

The negative electrode for a non-aqueous electrolyte secondary battery according to the present invention is characterized by using a carbonaceous material for a non-aqueous electrolyte secondary battery having an atom ratio (H/C) of hydrogen atoms to carbon atoms of at most 0.1, as determined by elemental analysis, and a degree of circularity of 0.50 to 0.95, wherein the electrode density is from 0.87 to 1.12 g/cc when a pressing pressure of 588 MPa (6.0 t/cm²) is applied. When the electrode density is less than 0.87 g/cc, this causes a decrease in the volume energy density, which is not preferable. The lower limit of the electrode density is preferably at least 0.87 g/cc, more preferably at least 0.90 g/cc, and even more preferably at least 0.93 g/cc when a pressing pressure of 588 MPa (6.0 t/cm²) is applied. On the other hand, when the active material density exceeds 1.12 g/cc, the gaps formed between the active materials become small, and the movement of lithium in the electrolyte solution is suppressed, which is not preferable. The upper limit of the active material density is preferably at most 1.12 g/cc, more preferably at most 1.10 g/cc, and even more preferably at most 1.08 g/cc when a pressing pressure of 588 MPa (6.0 t/cm²) is applied. The negative electrodes for a non-aqueous electrolyte secondary battery according to the present invention (Working Examples 5 to 8) demonstrate a minimal increase in electrode density when a pressing pressure of at least 245 MPa (2.5 t/cm²) is applied, even when the pressing pressure increases. On the other hand, conventional negative electrodes for a non-aqueous electrolyte secondary battery (Comparative Examples 10 and 15) demonstrate increases in electrode density in step with increases in the pressing pressure. That is, the electrode density of the conventional negative electrodes for a non-aqueous electrolyte secondary battery exceeds 1.12 g/cc when a pressing pressure of 588 MPa (6.0 t/cm²) is applied. In this way, a negative electrode for a non-aqueous electrolyte secondary battery with an increasing electrode density has low output characteristics (capacity retention in rapid discharge tests). On the other hand, the negative electrode for a non-aqueous electrolyte secondary battery, which demonstrates minimal increases in electrode density, of the present invention has excellent output characteristics (capacity retention in rapid discharge tests).

The electrode density can be calculated as follows.

Electrode density[g/cm³]=(W₂/S−W₁)/(t₂−t₁)

### [4] Non-Aqueous Electrolyte Secondary Battery

When a negative electrode for a non-aqueous electrolyte secondary battery is formed using the negative electrode material of the present invention, the other materials constituting the battery such as the positive electrode material, separators, and the electrolyte solution are not particularly limited, and various materials that have been conventionally used or proposed for non-aqueous solvent secondary batteries can be used.

For example, layered oxide-based (as represented by LiMO₂, where M is a metal such as LiCoO₂, LiNiO₂, LiMnO₂, or LiNiₓCo_{y}Mo_{z}O₂ (where x, y, and z represent composition ratios), for example), olivine-based (as represented by LiMPO₄, where M is a metal such as LiFePO₄, for example), and spinel-based (as represented by LiM₂O₄, where M is a metal such as LiMn₂O₄, for example) complex metal chalcogen compounds are preferable as positive electrode materials, and these chalcogen compounds may be mixed as necessary. A positive electrode is formed by molding these positive electrode materials with an appropriate binder together with a carbon material for imparting conductivity to the electrode and forming a layer on a conductive current collector.

A non-aqueous electrolyte solution used with this positive electrode and negative electrode combination is typically formed by dissolving an electrolyte in a non-aqueous solvent. One type or two or more types of organic solvents such as propylene carbonate, ethylene carbonate, dimethyl carbonate, diethyl carbonate, dimethoxyethane, diethoxyethane, γ-butyl lactone, tetrahydrofuran, 2-methyl tetrahydrofuran, sulfolane, or 1,3-dioxolane, for example, may be used in combination as a non-aqueous solvent. In addition, LiClO₄, LiPF₆, LiBF₄, LiCF₃SO₃, LiAsF₆, LiCl, LiBr, LiB(C₆H₅)₄, LiN(SO₃CF₃)₂, or the like is used as an electrolyte. A secondary battery is typically formed by making a positive electrode layer and a negative electrode layer formed as described above face one another via a liquid-permeable separator made of a nonwoven fabric or another porous material as necessary and immersing the product in an electrolyte solution. A permeable separator made of a nonwoven fabric or another porous material ordinarily used in secondary batteries can be used as a separator. Alternatively, a solid electrolyte formed from a polymer gel impregnated with an electrolyte solution may be used instead of or together with a separator.

### <Operations>

Although the mechanism by which the negative electrode for a non-aqueous electrolyte secondary battery according to the present invention described in item 13 or 14 exhibits excellent output characteristics (capacity retention in rapid discharging tests) has not been specifically determined but may be as follows. However, the present invention is not limited by the following explanation.

In general, when the active material density of a negative electrode is too high, each gap formed between the active materials in the electrode becomes small, and the output characteristics are diminished. On the other hand, when the active material density is too low, the contact between the active substances becomes poor, and the conductivity is reduced, which further decreases the energy density per unit volume. The negative electrode for a non-aqueous electrolyte secondary battery according to the present invention is preferably obtained by applying a pressing pressure of at least 96 MPa (1 t/cm²) so as to have an optimal active material density. In addition, there is minimal increase in the active material density or electrode density even if the pressing pressure increases. This may mean that the gaps between the respective carbonaceous materials (active materials) used are maintained in a stable manner. It is presumed that the negative electrode for a non-aqueous electrolyte secondary battery according to the present invention has output characteristics (capacity retention in rapid discharging tests) superior to those of a conventional negative electrode for a non-aqueous electrolyte secondary battery since the negative electrode has the characteristics described above.

Furthermore, although the mechanism by which the non-aqueous electrolyte secondary battery of the present invention using a negative electrode containing the carbonaceous material for a non-aqueous electrolyte secondary battery according to any one of items [4] to [6] has excellent output characteristics and exhibits excellent cycle characteristics has not been specifically determined, the mechanism may be as follows. However, the present invention is not limited by the following explanation.

It is presumed that since the carbonaceous material for a non-aqueous electrolyte secondary battery described above has a ratio Dv₉₀/Dv₁₀ of 1.05 to 3.00 and a degree of circularity of 0.50 to 0.95 (in particular, the surface structure of the carbonaceous material is altered by pulverizing the carbonaceous material), the gaps between particles are controlled to optimal levels when used as a negative electrode, which makes it possible to obtain a carbonaceous material for a non-aqueous electrolyte secondary battery exhibiting excellent cycle characteristics.

### EXAMPLES

The present invention will be described in detail hereinafter using working examples, but these working examples do not limit the scope of the present invention.

In addition, the measurement methods for the physical properties of the carbonaceous material for a non-aqueous electrolyte secondary battery according to the present invention (the “average particle size as determined by laser diffraction”, the “average interlayer spacing d₀₀₂ as determined by X-ray diffraction”, the “crystallite thickness L_{c})”, the “atom ratio (H/C) of hydrogen/carbon”, the “specific surface area”, and the “degree of circularity”) will be described hereinafter, but the physical properties described in this specification are based on values determined by the following methods.

### (Evaluation Test Items)

### <Particle Size Distribution>

Three drops of a dispersant (cationic surfactant “SN-WET 366” (made by the San Nopco Co.)) were added to approximately 0.1 g of a sample, and the dispersant was blended into the sample. Next, 30 mL of purified water was added, and after the sample was dispersed for approximately 2 minutes with an ultrasonic washer, the particle size distribution within the particle size range of 0.5 to 3000 μm was determined with a particle size distribution measurement device (“SALD-3000J” made by the Shimadzu Corporation).

The average particle size Dv₅₀ (μm) was determined from the resulting particle size distribution as the particle size yielding a cumulative volume of 50%. In addition, the particle size yielding a cumulative volume of 90% was defined as Dv90, and the particle size yielding a cumulative volume of 10% was defined as Dv₁₀. The value determined by dividing Dv90 by Dv₁₀ was defined as Dv₉₀/Dv₁₀ and used as an index of particle size distribution.

<Average Interlayer Spacing d₀₀₂ and Crystallite Thickness L_{c(002)} of the Carbonaceous Material>

A sample holder was filled with a carbonaceous material powder, and measurements were performed with a symmetrical reflection method using an X'Pert PRO made by the PANalytical B.V. Under conditions with a scanning range of 8<2θ<50° and an applied current/applied voltage of 45 kV/40 mA, an X-ray diffraction pattern was obtained using CuKα rays (λ=1.5418 Å) monochromated by an Ni filter as a radiation source. The correction of the diffraction pattern was not performed for the Lorentz polarization factor, absorption factor, or atomic scattering factor, and the diffraction angle was corrected using the diffraction line of the (111) surface of a high-purity silicone powder serving as a standard substance. The wavelength of the CuKα rays was set to 0.15418 nm, and dm was calculated by Bragg's equation. In addition, the thickness L_{c(002)} of crystallites in the c-axis direction was calculated with Scherrer's formula from a value β determined by subtracting the half width of the (111) diffraction line of the silicone powder from the half width determined by the integration of the 002 diffraction line. Here, calculations were made using the shape factor K=0.9.

$${d}_{002} = \frac{λ}{2 \cdot sin θ} \\ {L}_{c ( 002 )} = \frac{λ}{{β}_{1 / 2} \cdot cos θ} \qquad [ Formula 1 ]$$

### <Atom Ratio of Hydrogen Atoms/Carbon Atoms (H/C)>

The atom ratio was measured in accordance with the method prescribed in JIS M8819. That is, the ratio of the numbers of hydrogen/carbon atoms was determined from the weight ratio of hydrogen and carbon in a sample obtained by elemental analysis using a CHN analyzer (240011 made by Perkin Elmer Inc.).

### <Specific Surface Area>

The specific surface area was measured in accordance with the method prescribed in JIS Z8830. A summary is given below.

A value vₘ was determined by a one-point method (relative pressure x=0.3) based on nitrogen adsorption at the temperature of liquid nitrogen using the approximation vₘ=1/(v(1−x)) derived from the BET equation, and the specific area of the sample was calculated from the following formula: specific area=4.35×vₘ(m²/g)

(Here, vₘ is the amount of adsorption (cm³/g) required to form a monomolecular layer on the sample surface; v is the amount of adsorption (cm³/g) actually measured, and x is the relative pressure).

Specifically, the amount of adsorption of nitrogen in the carbonaceous substance at the temperature of liquid nitrogen was measured as follows using a “Flow Sorb II2300” made by MICROMERITICS.

A test tube was filled with the carbon material, and the test tube was cooled to −196° C. while infusing helium gas containing nitrogen gas at a concentration of 30 mol % so that the nitrogen was adsorbed in the carbon material. Next, the test tube was returned to room temperature. The amount of nitrogen desorbed from the sample at this time was measured with a thermal conductivity detector and used as the adsorption gas amount v.

### <True Density>

Measurements were performed using butanol in accordance with the method prescribed in JIS R7212. A summary is given below.

The mass (m₁) of a pycnometer with a bypass line having an internal volume of approximately 40 mL was precisely measured. Next, after a sample was placed flat at the base of the bottle so as to have a thickness of approximately 10 mm, the mass (m₂) was precisely measured. Next, 1-butanol was slowly added to the bottle to a depth of approximately 20 mm from the base. Next, the pycnometer was gently oscillated, and after it was confirmed that no large air bubbles were formed, the bottle was placed in a vacuum desiccator and gradually evacuated to a pressure of 2.0 to 2.7 kPa. The pressure was maintained for 20 minutes or longer, and after the generation of air bubbles stops, the bottle was removed and further filled with 1-butanol. After a stopper was inserted, the bottle was immersed in a constant-temperature water bath (adjusted to 30±0.03° C.) for at least 15 minutes, and the liquid surface of 1-butanol was aligned with the marked line. Next, the bottle was removed, and after the outside of the bottle was thoroughly wiped and the bottle was cooled to room temperature, the mass (m₄) was precisely measured. Next, the same pycnometer was filled with 1-butanol alone and immersed in a constant-temperature water bath in the same manner as described above. After the marked line was aligned, the mass (m₃) was measured. In addition, distilled water which was boiled immediately before use and from which the dissolved gas was removed was placed in the pycnometer and immersed in a constant-temperature water bath in the same manner as described above. After the marked line was aligned, the mass (m₅) was measured. The true density (ρ_{B}) was calculated using the following formula.

$${ρ}_{B} = \frac{{m}_{2} - {m}_{1}}{{m}_{2} - {m}_{1} - ( {m}_{4} - {m}_{3} )} \times \frac{{m}_{3} - {m}_{1}}{{m}_{5} - {m}_{1}} d \qquad [ Formula 2 ]$$

(Here, d is the specific gravity (0.9946) in water at 30° C.)

### <Degree of Circularity>

The carbon material particles were observed under an optical microscope, and plane image analysis was performed for greater than or equal to 30 particles having an average particle size Dv50±50% and not overlapping with or making contact with other particles using an image analysis system (IP-1000PC, A-zo-kun made by the Asahi Kasei Engineering Corporation). Then, the average of the degree of circularity C was calculated using the following formula.

C=4×π×S/l² [Formula 3]

Here, l: circumference, S: area.

### Working Example 1

### (1) Production of a Porous Spherical Pitch

First, 68 kg of a petroleum pitch having a softening point of 210° C., a quinoline insoluble content of 1%, and an H/C atom ratio of 0.63 and 32 kg of naphthalene were loaded into a pressure-resistant vessel having a mixing impeller and an internal volume of 300 L. After the substances were melted and mixed while heating at 190° C., the mixture was cooled to 80 to 90° C. and extruded to form a string-like compact with a diameter of approximately 500 μm. Next, this string-shaped compact was crushed so that the ratio of the diameter and the length was approximately 1.5, and the resulting crushed material was placed in an aqueous solution of 0.53% polyvinyl alcohol (degree of saponification: 88%) heated to 93° C. This was dispersed while stirring and then cooled to form a spherical pitch compact. After most of the water was removed by filtration, the naphthalene in the pitch compact was extracted with n-hexane in a volume approximately six times that of the spherical pitch compact.

### (2) Production of a Carbonaceous Material

A porous spherical pitch obtained as described above was subjected to oxidation treatment while passing the sample through heated air and maintaining the product at 260° C. for one hour, and heat-infusible porous pitch was thus obtained. After the resulting heat-infusible porous pitch compact was subjected to pre-heat treatment for one hour at 600° C. in a nitrogen gas atmosphere, the sample was pulverized using a jet mill and classified to form carbon precursor microparticles. Next, this carbon precursor was subjected to final heat treatment for one hour at 1200° C. to form a carbonaceous material 1 with an average particle size of 10.2 μm. The characteristics of the resulting carbonaceous material 1 are shown in Table 1.

### Working Example 2

A carbonaceous material 2 was obtained in the same manner as in Working Example 1 with the exception of setting the average particle size to 17.9 μm. The characteristics of the resulting carbonaceous material 2 are shown in Table 1.

### Working Example 3

First, 30 g of coconut shell carbon (made in Indonesia) pulverized to an average particle size of at most 1 mm and 100 g of 35% hydrochloric acid were placed in a 300 mL Erlenmeyer flask, and after the flask was shaken for one hour at 50° C., the mixture was filtered. The filtered residue was further washed sufficiently with ion-exchange water and dried for two hours at 120° C. to form de-mineral carbon. After the de-mineral carbon obtained in this way was subjected to pre-heat treatment for one hour at 600° C. in a nitrogen gas atmosphere, the sample was pulverized using a rod mill and then classified using a sieve to form carbon precursor microparticles. The sample was then subjected to final heat treatment for one hour at 1250° C. to form a carbonaceous material 3 with an average particle size of 27.0 μm. The characteristics of the resulting carbonaceous material 3 are shown in Table 1.

### Working Example 4

An aqueous dispersion solvent containing 250 g of a 4% methylcellulose aqueous solution and 2.0 g of sodium nitrite was prepared in 1695 g of water. On the other hand, a monomer mixture containing 500 g of acrylonitrile and 2.9 g of 2,2′-azobis-2,4-dimethylvaleronitrile was prepared. An aqueous dispersion solvent was added to this monomer mixture and mixed while stirring for 15 minutes at 2000 rpm with a homogenizer to produce micro-droplets of the monomer mixture. An aqueous dispersion solvent containing the micro-droplets of this polymerizable mixture was loaded into a polymerization tank with a stirrer (10 L) and then polymerized for 20 hours at 55° C. using a warm bath. After the resulting polymerization product was filtered from the aqueous phase, the product was dried and run through a sieve to form a spherical synthetic resin with an average particle size of 40 μm.

The resulting synthetic resin was subjected to oxidation treatment while passing the sample through heated air and maintaining the product at 250° C. for 5 hours, and a heat-infusible precursor was thus obtained. After this precursor was subjected to pre-heat treatment at 800° C. in a nitrogen gas atmosphere, the sample was pulverized using a rod mill and then classified using a sieve to form carbon precursor microparticles. Next, this carbon precursor was subjected to final heat treatment for one hour at 1200° C. to form a carbonaceous material with an average particle size of 18.6 μm. The characteristics of the resulting carbonaceous material are shown in Table 1 below.

### Comparative Example 1

A comparative carbonaceous material 1 was obtained in the same manner as in Working Example 1 with the exception of setting the average particle size to 10.6 μm and setting the final heat treatment temperature to 800° C. The characteristics of the resulting comparative carbonaceous material 1 are shown in Table 1 below.

### Comparative Example 2

A comparative carbonaceous material 2 was obtained in the same manner as in Working Example 1 with the exception of setting the average particle size of the carbonaceous material to 10.4 μm and performing pulverization using a rod mill. The average particle size distribution was not adjusted with a classifier. The characteristics of the resulting comparative carbonaceous material 2 are shown in Table 1 below.

### Comparative Example 3

A comparative carbonaceous material 3 was obtained in the same manner as in Working Example 1 with the exception of setting the average particle size of the carbonaceous material to 36 μm. The characteristics of the resulting comparative carbonaceous material 3 are shown in Table 1 below.

### Comparative Example 4

A porous spherical pitch was obtained by repeating the operations of “(1) Production of a Porous Spherical Pitch” in Working Example 1.

After the resulting porous spherical pitch was pulverized to an average particle size of 13 μm using a rod mill, the sample was subjected to oxidation treatment while passing the sample through heated air and maintaining the product at 260° C. for one hour, and a heat-infusible porous pitch powder was thus obtained. The resulting infusible pitch powder was subjected to preliminary carbonization for one hour at 600° C. in a nitrogen gas atmosphere. Next, this carbon precursor powder was subjected to final heat treatment for one hour at 1200° C. to form a comparative carbonaceous material 4 with an average particle size of 10.8 μm. The characteristics of the resulting comparative carbonaceous material 4 are shown in Table 1 below.

### Comparative Example 5

Needle coke was pulverized with a rod mill to form a powdered carbon precursor with an average particle size of 12 μm. Next, the powdered carbon precursor was loaded into a furnace, and once the temperature of the furnace reached 1200° C. under a nitrogen air flow, final heat treatment was performed while maintaining the sample at 1200° C. for one hour. The sample was then cooled to form a powdered comparative carbonaceous material 5 with an average particle size of 7.8 μm. The characteristics of the resulting comparative carbonaceous material 5 are shown in Table 1 below.

### Comparative Example 6

A spherical phenol resin with an average particle size of 17 μm (Maririn: made by Gun Ei Chemical Industry Co., Ltd.) was heated to 600° C. in a nitrogen gas atmosphere (normal pressure) and subjected to pre-heat treatment while maintaining the sample at 600° C. for one hour to form a spherical carbon precursor with at most 2% volatile content. Next, the spherical carbon precursor was loaded into a furnace, and once the temperature of the furnace reached 1200° C. under a nitrogen air flow, final heat treatment was performed while maintaining the sample at 1200° C. for one hour. The sample was then cooled to form a spherical comparative carbonaceous material 6 with an average particle size of 14 μm. The characteristics of the resulting comparative carbonaceous material 6 are shown in Table 1 below.

### Comparative Example 7

An aqueous dispersion solvent containing 250 g of a 4% methylcellulose aqueous solution and 1.0 g of sodium nitrite was prepared in 1695 g of water. On the other hand, a monomer mixture containing 255 g of acrylonitrile, 157 g of styrene, 118 g of divinyl benzene (purity: 57%), and 2.9 g of 2,2′-azobis-2,4-dimethylvaleronitrile was prepared. An aqueous dispersion solvent was added to this monomer mixture and mixed while stirring for 10 minutes at 1800 rpm with a homogenizer to produce micro-droplets of the monomer mixture. An aqueous dispersion solvent containing the micro-droplets of this polymerizable mixture was loaded into a polymerization tank with a stirrer (10 L) and then polymerized for 20 hours at 55° C. using a warm bath. After the resulting polymerization product was filtered from the aqueous phase, the product was dried and run through a sieve to form a spherical synthetic resin with an average particle size of 51 μm.

The resulting synthetic resin was subjected to oxidation treatment while passing the sample through heated air and maintaining the product at 290° C. for one hour, and a heat-infusible precursor was thus obtained. This was subjected to pre-heat treatment at 800° C. in a nitrogen gas atmosphere to form carbon precursor microparticles. After this was pulverized using a rod mill to form carbon precursor microparticles with an average particle size of 19.0 μm, the sample was subjected to final heat treatment for one hour at 1200° C. to form a comparative carbonaceous material 7 with an average particle size of 18.0 μm. The characteristics of the resulting comparative carbonaceous material 7 are shown in Table 1.

### Comparative Example 8

A synthetic resin with an average particle size of 15 μm was obtained with the same method as in Comparative Example 7. After this was subjected to oxidation treatment and pre-heat treatment in the same manner as in Comparative Example 3, the sample was subjected to final heat treatment without being pulverized. As a result, a carbonaceous material with an average particle size of 10.6 μm was obtained. The characteristics of the resulting comparative carbonaceous material 8 are shown in Table 1.

Negative electrodes and a non-aqueous electrolyte secondary batteries were produced using the carbonaceous materials 1 to 4 and the comparative carbonaceous materials 1 to 8 obtained in Working Examples 1 to 4 and Comparative Examples 1 to 8, and the electrode performances thereof were evaluated.

### Working Example 5

First, NMP was added to 90 parts by weight of the carbonaceous material 1 obtained in Working Example 1 and 10 parts by weight of polyvinylidene fluoride (“KF#1100” made by the Kureha Corporation). This was formed into a pasty consistency and applied uniformly to copper foil. After this was dried, the sample was punched out of the copper foil in a circle shape with a diameter of 15 mm, and this was pressed with a pressing pressure of 392 MPa (4.0 t/cm²) to form an electrode 5. The amount of the carbon material in the electrode was adjusted to approximately 10 mg.

The characteristics of the resulting electrode 5 are shown in Table 2.

### Working Example 6

An electrode 6 was obtained by repeating the operations of Working Example 5 with the exception of using the carbonaceous material 2 obtained in Working Example 2 instead of the carbonaceous material 1.

### Working Example 7

An electrode 7 was obtained by repeating the operations of Working Example 5 with the exception of using the carbonaceous material 3 obtained in Working Example 3 instead of the carbonaceous material 1 and setting the pressing pressure to 245 MPa (2.5 t/cm²).

### Working Example 8

An electrode 8 was obtained by repeating the operations of Working Example 5 with the exception of using the carbonaceous material 4 obtained in Working Example 4 instead of the carbonaceous material 1.

### Comparative Example 9

A comparative electrode 9 was obtained by repeating the operations of Working Example 5 with the exception of using the comparative carbonaceous material 1 obtained in Comparative Example 1 instead of the carbonaceous material 1.

### Comparative Example 10

A comparative electrode 10 was obtained by repeating the operations of Working Example 5 with the exception of using the comparative carbonaceous material 2 obtained in Comparative Example 2 instead of the carbonaceous material 1.

### Comparative Example 11

A comparative electrode 11 was obtained by repeating the operations of Working Example 5 with the exception of using the comparative carbonaceous material 3 obtained in Comparative Example 3 instead of the carbonaceous material 1.

### Comparative Example 12

A comparative electrode 12 was obtained by repeating the operations of Working Example 5 with the exception of using the comparative carbonaceous material 4 obtained in Comparative Example 4 instead of the carbonaceous material 1.

### Comparative Example 13

A comparative electrode 12 was obtained by repeating the operations of Working Example 5 with the exception of using the comparative carbonaceous material 5 obtained in Comparative Example 5 instead of the carbonaceous material 1.

### Comparative Example 14

A comparative electrode 14 was obtained by repeating the operations of Working Example 5 with the exception of using the comparative carbonaceous material 6 obtained in Comparative Example 6 instead of the carbonaceous material 1.

### Comparative Example 15

A comparative electrode 15 was obtained by repeating the operations of Working Example 5 with the exception of using the comparative carbonaceous material 7 obtained in Comparative Example 7 instead of the carbonaceous material 1.

### Comparative Example 16

A comparative electrode 16 was obtained by repeating the operations of Working Example 5 with the exception of using the comparative carbonaceous material 8 obtained in Comparative Example 8 instead of the carbonaceous material 1 and not applying pressure at a pressing pressure of 392 MPa (4.0 t/cm²).

Non-aqueous electrolyte secondary batteries were produced by means of the following operations (a) to (c) using the electrodes obtained in Working Examples 5 to 8 and Comparative Examples 9 to 16, and the electrode and battery performances thereof were evaluated.

### (a) Production of a Test Battery

Although the carbon material of the present invention is suitable for forming a negative electrode for a non-aqueous electrolyte secondary battery, in order to precisely evaluate the discharge capacity (de-doping capacity) and the irreversible capacity (non-de-doping capacity) of the battery active material without being affected by fluctuation in the performances of the counter electrode, a lithium secondary battery was formed using the electrode obtained above together with a counter electrode comprising lithium metal with stable characteristics, and the characteristics thereof were evaluated.

The lithium electrode was prepared inside a glove box in an Ar atmosphere. An electrode (counter electrode) was formed by spot-welding a stainless steel mesh disc with a diameter of 16 mm on the outer lid of a 2016-size coin-type battery can in advance, stamping a thin sheet of metal lithium with a thickness of 0.8 mm into a disc shape with a diameter of 15 mm, and pressing the thin sheet of metal lithium into the stainless steel mesh disc.

Using a pair of electrodes produced in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2016-size coin-type non-aqueous electrolyte lithium secondary battery in an Ar glove box.

### (b) Measurement of Battery Capacity

Charge-discharge tests were performed on a lithium secondary battery with the configuration described above using a charge-discharge tester (“TOSCAT” made by Toyo System Co., Ltd.). A lithium doping reaction for inserting lithium into the carbon electrode was performed with a constant-current/constant-voltage method, and a de-doping reaction was performed with a constant-current method. Here, in a battery using a lithium chalcogen compound for the positive electrode, the doping reaction for inserting lithium into the carbon electrode is called “charging”, and in a battery using lithium metal for a counter electrode, as in the test battery of the present invention, the doping reaction for the carbon electrode is called “discharging”. The manner in which the doping reactions for inserting lithium into the same carbon electrode thus differs depending on the pair of electrodes used. Therefore, the doping reaction for inserting lithium into the carbon electrode will be described as “charging” hereinafter for the sake of convenience. Conversely, “discharging” refers to a charging reaction in the test battery but is described as “discharging” for the sake of convenience since it is a de-doping reaction for removing lithium from the carbon material. The charging method used here is a constant-current/constant-voltage method. Specifically, constant-current charging was performed at 0.5 mA/cm² until the terminal voltage reached 0 V. After the terminal voltage reached 0 mV, constant-voltage charging was performed at a terminal voltage of 0 mV, and charging was continued until the current value reached 20 μA. At this time, a value determined by dividing the electricity supply by the weight of the carbon material of the electrode is defined as the charge capacity per unit weight of the carbon material (mAh/g). After the completion of charging, the battery circuit was opened for 30 minutes, and discharging was performed thereafter. Discharging was performed at a constant current of 0.5 mA/cm² until the final voltage reached 1.5 V. At this time, a value determined by dividing the electrical discharge by the weight of the carbon material of the electrode is defined as the discharge capacity per unit weight of the carbon material (mAh/g). The irreversible capacity was calculated as the discharge capacity subtracted from the charge capacity.

The charge-discharge capacity and irreversible capacity were determined by averaging n=3 measurements for test batteries produced using the same sample.

### (c) Rapid Charge-Discharge Test.

After charging-discharging were performed in accordance with (b) for a lithium secondary battery with the configuration described above, charging-discharging were performed once again with the same method.

Next, after constant-current charging was performed at 0.5 mA/cm² until the terminal voltage reached 0 V, constant-voltage charging was performed at a terminal voltage of 0 mV, and charging was performed until the current value declined to 20 μA. After charging was complete, the battery circuit was opened for 30 minutes, and constant-current discharging was then performed at 25 mA/cm² until the terminal voltage reached 1.5 V. A value determined by dividing the electrical discharge at this time by the weight of the carbon material of the electrode is defined as the rapid discharge capacity (mAh/g). In addition, a value determined by dividing the discharge capacity at 25 mA/cm² by the second discharge capacity at 0.5 mA/cm² is defined as the output characteristics (%).

Next, n=3 measurements for test batteries produced using the same sample were averaged.

### (d) Cycle Test

First, NMP was added to 94 parts by weight of each of the carbon materials obtained in Working Examples 1 to 4 and Comparative Examples 1 to 6 and 6 parts by weight of polyvinylidene fluoride (KF#9100 made by the Kureha Corporation). This was formed into a pasty consistency and applied uniformly to copper foil. After the sample was dried, the coated electrode was punched into a circle shape with a diameter of 15 mm, and this was pressed so as to form a negative electrode. The amount of the carbon material in the electrode was adjusted to approximately 10 mg.

Next, NMP was added to 94 parts by weight of lithium cobaltate (LiCoO₂), 3 parts by weight of carbon black, and 3 parts by weight of polyvinylidene fluoride (KF#1300 made by the Kureha Corporation). This was formed into a pasty consistency and then applied uniformly to aluminum foil. After the sample was dried, the coated electrode was punched into a circle shape with a diameter of 14 mm. Here, the amount of lithium cobaltate in the positive electrode was adjusted so as to achieve 95% of the charge capacity of the negative electrode active material measured in (c). The volume of lithium cobaltate was calculated as 150 mAh/g.

Using a pair of electrodes prepared in this way, LiPF₆ was added at a proportion of 1.5 mol/L to a mixed solvent prepared by mixing ethylene carbonate, dimethyl carbonate, and methyl ethyl carbonate at a volume ratio of 1:2:2 as an electrolyte solution. A polyethylene gasket was used as a fine porous membrane separator made of borosilicate glass fibers with a diameter of 19 mm to assemble a 2016-size coin-type non-aqueous electrolyte lithium secondary battery in an Ar glove box.

Here, cycle tests were begun after the sample was aged by repeating three cycles of charging and discharging. Under the constant-current/constant-voltage conditions used in the cycle tests, charging was performed at a constant current density of 2.5 mA/cm² until the battery voltage reached 4.2 V, and charging was then performed until the current value reached 50 μA while constantly changing the current value so as to maintain the voltage at 4.2 V (while maintaining a constant voltage). After the completion of charging, the battery circuit was opened for 30 minutes, and discharging was performed thereafter. Discharging was performed at a constant current density of 2.5 mA/cm² until the battery voltage reached 2.75 V. This charging and discharging were repeated for 50 cycles at 25° C., and the discharge capacity of the 50th cycle was divided by the discharge capacity of the 1st cycle and defined as the cycle characteristics (%).

The characteristics of the resulting lithium secondary battery are shown in Table 2.

TABLE 1

| | | | Heat | BuOH | | | | | |
|---|---|---|---|---|---|---|---|---|---|
| | | | treatment | true | | | | | |
| | Raw | Pulverization | temperature | density | | Dv₁₀ | Dv₅₀ | Dv₉₀ | |
| | materials | step | ° C. | g/cm³ | H/C | μm | μm | μm | Dv₉₀/Dv₁₀ |
| Working | Petroleum | Before final | 1200 | 1.52 | 0.03 | 7.0 | 10.2 | 14.5 | 2.07 |
| Example 1 | pitch | heat treatment | | | | | | | |
| Working | Petroleum | Before final | 1200 | 1.52 | 0.03 | 13.5 | 17.9 | 23.6 | 1.75 |
| Example 2 | pitch | heat treatment | | | | | | | |
| Working | Coconut | Before final | 1250 | 1.46 | 0.06 | 13.7 | 27.0 | 40.4 | 2.96 |
| Example 3 | shells | heat treatment | | | | | | | |
| Working | PAN resin | Before final | 1200 | 1.60 | 0.02 | 10.8 | 18.6 | 25.0 | 2.33 |
| Example 4 | | heat treatment | | | | | | | |
| Comparative | Petroleum | Before final | 800 | 1.45 | 0.12 | 7.1 | 10.6 | 15.1 | 2.14 |
| Example 1 | pitch | heat treatment | | | | | | | |
| Comparative | Petroleum | Before final | 1200 | 1.52 | 0.03 | 3.4 | 10.4 | 17.4 | 5.12 |
| Example 2 | pitch | heat treatment | | | | | | | |
| Comparative | Petroleum | Before final | 1200 | 1.52 | 0.03 | 28.0 | 36.3 | 46.7 | 1.67 |
| Example 3 | pitch | heat treatment | | | | | | | |
| Comparative | Petroleum | Before | 1200 | 1.52 | 0.03 | 3.5 | 10.8 | 18.2 | 5.16 |
| Example 4 | pitch | infusibilization | | | | | | | |
| Comparative | Needle | Before final | 1200 | 2.01 | 0.01 | 4.5 | 7.8 | 10.6 | 2.35 |
| Example 5 | coke | heat treatment | | | | | | | |
| Comparative | Phenol | None | 1200 | 1.49 | 0.03 | 11.0 | 14 | 18.7 | 1.70 |
| Example 6 | resin | | | | | | | | |
| Comparative | AN-type | Before final | 1200 | 1.46 | 0.02 | 7.2 | 18.0 | 28.2 | 3.93 |
| Example 7 | resin | heat treatment | | | | | | | |
| Comparative | AN-type | None | 1200 | 1.46 | 0.02 | 8.1 | 10.6 | 14.3 | 1.77 |
| Example 8 | resin | | | | | | | | |

| | Specific surface area | | | |
|---|---|---|---|---|
| | m²/g | Degree of circularity | d₀₀₂ | L_{c} |
| Working Example 1 | 3.3 | 0.793 | 0.383 | 1.2 |
| Working Example 2 | 1.7 | 0.776 | 0.383 | 1.2 |
| Working Example 3 | 3.4 | 0.671 | 0.389 | 1.1 |
| Working Example 4 | 4.3 | 0.778 | 0.370 | 1.3 |
| Comparative Example 1 | 41 | 0.793 | 0.407 | 0.9 |
| Comparative Example 2 | 4.8 | 0.793 | 0.383 | 1.2 |
| Comparative Example 3 | 0.7 | 0.654 | 0.383 | 1.2 |
| Comparative Example 4 | 2.2 | 0.798 | 0.383 | 1.2 |
| Comparative Example 5 | 2.5 | 0.710 | 0.349 | 2.5 |
| Comparative Example 6 | >30 | 0.970 | 0.386 | 0.9 |
| Comparative Example 7 | 3.8 | 0.763 | 0.382 | 1.1 |
| Comparative Example 8 | 1.1 | 0.963 | 0.382 | 1.1 |

TABLE 2

| | Discharge | Irreversible | | | |
|---|---|---|---|---|---|
| | capacity | capacity | | Output | Cycle |
| | mAh/g | mAh/g | Efficiency % | characteristics % | characteristics |
| Working Example 5 | 470 | 61 | 88 | 61.7 | 93.0 |
| Working Example 6 | 452 | 71 | 86.4 | 67 | 92.4 |
| Working Example 7 | 460 | 78 | 85.5 | 64.1 | 96.1 |
| Working Example 8 | 424 | 83 | 83.7 | 61.2 | 91.7 |
| Comparative | 341 | 348 | 49.6 | 45.3 | <70 |
| Example 9 | | | | | |
| Comparative | 451 | 61 | 88.1 | 49.4 | 95.8 |
| Example 10 | | | | | |
| Comparative | 392 | 111 | 77.9 | 52.8 | 90.9 |
| Example 11 | | | | | |
| Comparative | 445 | 51 | 89.7 | 55.8 | <70 |
| Example 12 | | | | | |
| Comparative | 233 | 50 | 82 | 63.5 | <70 |
| Example 13 | | | | | |
| Comparative | 415 | 132 | 76 | 51.2 | <70 |
| Example 14 | | | | | |
| Comparative | 481 | 110 | 81.5 | 49.1 | — |
| Example 15 | | | | | |
| Comparative | 452 | 103 | 81.5 | 58.0 | — |
| Example 16 | | | | | |

As described in Table 2, the lithium secondary batteries of Working Examples 5 to 8 using the carbonaceous materials 1 to 4 exhibited high output characteristics of at least 61% and high cycle characteristics of at least 91%. On the other hand, the lithium secondary batteries of Comparative Examples 9 and 12 to 14 using the comparative carbonaceous materials 1 and 4 to 6 exhibited cycle characteristics of less than 70%. In addition, the lithium secondary battery of Comparative Example 10 using the comparative carbonaceous material 2 having a ratio Dv₉₀/Dv₁₀ of 5.15 exhibited high cycle characteristics, but the output characteristics (capacity retention) were low at 49.4%. Furthermore, the lithium secondary battery of Comparative Example 11 using the comparative carbonaceous material 3 having an average particle size Dv₅₀ of 36 μm also exhibited high cycle characteristics, but the output characteristics (capacity retention) were also low at 52.8%.

### <Measurement of Electrode Active Material Density and Electrode Density>

The active material densities and electrode densities of the electrodes 5 to 8 and the comparative electrodes 9, 10, 15, and 16 obtained in Working Examples 5 to 8 and Comparative Examples 9, 10, 15, and 16 were calculated using the following methods. The results are shown in Table 3. Here, the “discharge capacity”, “irreversible capacity”, “efficiency”, and “output characteristics” of the secondary batteries using the electrodes described in Table 2 are listed once again.

### (Active Material Density)

The active material density was calculated as follows.

Active material density[g/cm³]=(W₂/S−W₁)/(t₂−t₁)×P

The negative electrode is produced by applying a mixture of a graphite compound, which has a mass ratio of P in the carbonaceous material, and a binder to a current collector having a thickness of t₁ [cm] and a mass per unit area of W₁ [g/cm²] and punching out the produced negative electrode having a thickness of t₂ [cm] with a prescribed area S [cm²] by applying pressure, wherein the mass of the negative electrode after punching is defined as W₂ [g].

### (Electrode Density)

The electrode density was calculated as follows.

Electrode density[g/cm³]=(W₂/S−W₁)/(t₂−t₁)

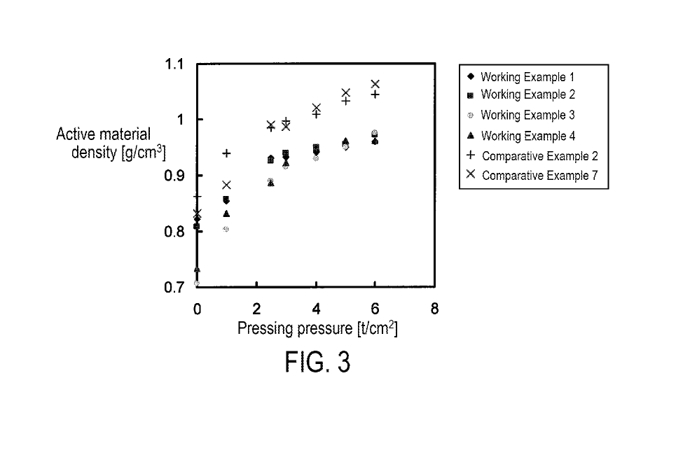

Furthermore, electrodes were produced by repeating the operations of Working Example 5 using the carbonaceous materials 1 to 4 and the comparative carbonaceous materials 1, 2, and 7 obtained in Working Examples 1 to 4 and Comparative Examples 1, 2, and 7 and setting the pressing pressure to 2.5 t/cm², 3 t/cm², 4 t/cm², 5 t/cm², or 6 t/cm². The active material densities and electrode densities of the resulting electrodes are shown in Table 4 and FIGS. 2 and 3.

As shown in Table 4 and FIGS. 2 and 3, the negative electrode of the present invention exhibits practically no increase in electrode density when a pressing pressure of at least 2.5 t/cm² is applied, even when the pressing pressure increases. On the other hand, it can be seen that the electrodes of Comparative Examples 10 and 11 exhibit increases in electrode density in step with increases in pressing pressure.

TABLE 3

| | Pressing | Active | | | | | | |
|---|---|---|---|---|---|---|---|---|
| | pressure | material | Electrode | Coated | Discharge | Irreversible | | |
| | MPa | density | density | weight | capacity | capacity | | Output |
| | (t/cm²) | g/cm³ | g/cm³ | g/m² | mAh/g | mAh/g | Efficiency % | characteristics % |
| Working | 392 (4.0) | 0.941 | 1.045 | 57.3 | 470 | 61 | 88.0 | 61.7 |
| Example 5 | | | | | | | | |
| Working | 392 (4.0) | 0.950 | 1.055 | 56.2 | 452 | 71 | 86.4 | 67.0 |
| Example 6 | | | | | | | | |
| Working | 245 (2.5) | 0.889 | 0.954 | 57.3 | 460 | 78 | 85.5 | 64.1 |
| Example 7 | | | | | | | | |
| Working | 392 (4.0) | 0.948 | 1.053 | 57.0 | 424 | 83 | 83.7 | 62.1 |
| Example 8 | | | | | | | | |
| Comparative | 392 (4.0) | 0.937 | 0.997 | 56.2 | 341 | 348 | 49.6 | 45.3 |
| Example 9 | | | | | | | | |
| Comparative | 392 (4.0) | 1.008 | 1.120 | 52.7 | 451 | 61 | 88.1 | 49.4 |
| Example 10 | | | | | | | | |
| Comparative | 392 (4.0) | 1.018 | 1.131 | 56.1 | 481 | 110 | 81.5 | 49.1 |
| Example 15 | | | | | | | | |
| Comparative | None | 0.730 | 0.811 | 57.3 | 452 | 103 | 81.5 | 58.0 |
| Example 16 | | | | | | | | |

TABLE 4

| | Active material density (g/cm³) | | | | | Electrode density (g/cm³) | | | | |
|---|---|---|---|---|---|---|---|---|---|---|
| Pressing pressure | 2.5 t/cm² | 3 t/cm² | 4 t/cm² | 5 t/cm² | 6 t/cm² | 2.5 t/cm² | 3 t/cm² | 4 t/cm² | 5 t/cm² | 6 t/cm² |
| Working Example 1 | 0.930 | 0.933 | 0.941 | 0.950 | 0.959 | 1.033 | 1.037 | 1.045 | 1.056 | 1.066 |
| Working Example 2 | 0.925 | 0.939 | 0.950 | 0.955 | 0.971 | 1.027 | 1.043 | 1.055 | 1.061 | 1.078 |
| Working Example 3 | 0.889 | 0.915 | 0.929 | 0.950 | 0.975 | 0.954 | 0.973 | 0.989 | 1.011 | 1.037 |
| Working Example 4 | 0.886 | 0.922 | 0.948 | 0.961 | 0.961 | 0.985 | 1.025 | 1.053 | 1.068 | 1.068 |
| Comparative | 0.846 | 0.872 | 0.897 | 0.922 | 0.965 | 0.940 | 0.968 | 0.997 | 1.024 | 1.073 |
| Example 1 | | | | | | | | | | |
| Comparative | 0.985 | 0.996 | 1.008 | 1.032 | 1.044 | 1.094 | 1.107 | 1.120 | 1.147 | 1.160 |
| Example 2 | | | | | | | | | | |
| Comparative | 0.990 | 0.987 | 1.021 | 1.047 | 1.063 | 1.101 | 1.097 | 1.134 | 1.163 | 1.181 |
| Example 7 | | | | | | | | | | |

As described in Table 3, the lithium-ion secondary batteries using the electrodes 1 to 4 (Working Examples 5 to 8) exhibited high output characteristics (capacity retention) of at least 61% in rapid charge-discharge tests. On the other hand, the comparative electrode 1 having a low heat treatment temperature and the comparative electrodes to 2 to 4 having unsuitable active material densities and electrode densities (Comparative Examples 9, 10, 15, and 16) exhibited low capacity retention of less than 60%.

### INDUSTRIAL APPLICABILITY

A non-aqueous secondary battery using the carbonaceous material or negative electrode of the present invention has excellent output characteristics (rate characteristics) and/or cycle characteristics, so the battery can be used for hybrid electric vehicles (HEV) and electric vehicles (EV), which require long life and high input/output characteristics.

The present invention was described above using specific modes of embodiment, but modifications and improvements apparent to persons having ordinary skill in the art are also included in the scope of the present invention.

1-15. (canceled)

16. A carbonaceous material for a non-aqueous electrolyte battery having an atom ratio (H/C) of hydrogen atoms to carbon atoms of at most 0.1, as determined by elemental analysis, and a degree of circularity of 0.50 to 0.95.

17. The carbonaceous material for a non-aqueous electrolyte battery according to claim 16, a true density being from 1.4 to 1.7 g/cm³.

18. The carbonaceous material for a non-aqueous electrolyte battery according to claim 16, an average particle size Dv₅₀ being from 3 to 35 μm.

19. The carbonaceous material for a non-aqueous electrolyte battery according to claim 16, a ratio Dv₉₀/Dv₁₀ being from 1.05 to 3.00.

20. The carbonaceous material for a non-aqueous electrolyte secondary battery according to claim 19, the adjustment of the ratio Dv₉₀/Dv₁₀ to 1.05 to 3.00 being performed by pulverization.

21. The carbonaceous material for a non-aqueous electrolyte secondary battery according to claim 16, the carbon precursor being at least one selected from the group consisting of infusible petroleum pitch or tar, infusible coal pitch or tar, plant-derived organic material, infusible thermoplastic resins, and thermosetting resins.

22. A negative electrode for a non-aqueous electrolyte secondary battery comprising the carbonaceous material described in claim 16.

23. The negative electrode for a non-aqueous electrolyte secondary battery according to claim 16, wherein upon application of a pressing pressure of 588 MPa (6.0 t/cm²), an active material density is from 0.85 to 1.00 g/cc.

24. The negative electrode for a non-aqueous electrolyte secondary battery according to claim 16, wherein upon application of a pressing pressure of 588 MPa (6.0 t/cm²), an electrode density is from 0.87 to 1.12 g/cc.

25. A non-aqueous electrolyte secondary battery comprising the negative electrode described in claim 16.

26. A carbonaceous material for a non-aqueous electrolyte battery having a true density of 1.4 to 1.7 g/cm³, an atom ratio (H/C) of hydrogen atoms to carbon atoms of at most 0.1, as determined by elemental analysis, an average particle size Dv₅₀ of 3 to 35 μm, and a ratio Dv₉₀/Dv₁₀ of 1.05 to 3.00; the carbonaceous material for a non-aqueous electrolyte battery being obtained by:
(a) pulverizing a heat-infusible carbon precursor and then subjecting the carbon precursor to final heat treatment at a temperature of 900 to 1600° C.; or
(b) subjecting a heat-infusible carbon precursor to final heat treatment at a temperature of 900 to 1600° C. and then pulverizing the carbon precursor.

27. The carbonaceous material for a non-aqueous electrolyte secondary battery according to claim 26, the carbon precursor being at least one selected from the group consisting of infusible petroleum pitch or tar, infusible coal pitch or tar, plant-derived organic material, infusible thermoplastic resins, and thermosetting resins.

28. A negative electrode for a non-aqueous electrolyte secondary battery comprising the carbonaceous material described in claim 26.

29. The negative electrode for a non-aqueous electrolyte secondary battery according to claim 26, wherein upon application of a pressing pressure of 588 MPa (6.0 t/cm²), an active material density is from 0.85 to 1.00 g/cc.

30. The negative electrode for a non-aqueous electrolyte secondary battery according to claim 26, wherein upon application of a pressing pressure of 588 MPa (6.0 t/cm²), an electrode density is from 0.87 to 1.12 g/cc.

31. A non-aqueous electrolyte secondary battery comprising the negative electrode described in claim 26.

32. A production method for a carbonaceous material for a non-aqueous electrolyte secondary battery negative electrode, the production method comprising the steps of:
(a) pulverizing a heat-infusible carbon precursor and then adjusting a ratio Dv₉₀/Dv₁₀ of the resulting carbonaceous material for a non-aqueous electrolyte secondary battery negative electrode to a range of 1.05 to 3.00; and
(b) subjecting a carbon precursor to final heat treatment at 900 to 1600° C.

33. The production method for a carbonaceous material for a non-aqueous electrolyte secondary battery negative electrode according to claim 32, the production method including a step of (c) pre-heat treatment the carbon precursor at a temperature of at least 300° C. and less than 900° C. prior to the step (a) of pulverizing.

34. The production method for a carbonaceous material for a non-aqueous electrolyte secondary battery negative electrode according to claim 32, the carbon precursor being a petroleum pitch or tar, a coal pitch or tar, or a thermoplastic resin; and
the production method including a step of (d) infusibilizing a carbonaceous precursor prior to step (c).

35. The production method for a carbonaceous material for a non-aqueous electrolyte secondary battery negative electrode according to claim 32, the carbon precursor being plant-derived organic material or a thermosetting resin.
